(19) United States
(12) Patent Application Publication
(10) Pub. No.: US 2023/0313612 A1
(43) Pub. Date: Oct. 5, 2023

(54) WHEELED PLATFORM SYSTEM

(71) Applicant: LITTLE GIANT LADDER SYSTEMS, LLC, Springville, UT (US)

(72) Inventors: Aaron Bruce Major, Nephi, UT (US); Brian B. Russell, Saratoga Springs, UT (US); N. Ryan Moss, Mapleton, UT (US); Steven S. Miner, Springville, UT (US); Tallon C. Beckstrom, Spanish Fork, UT (US); B. Scott Maxfield, Mapleton, UT (US); Travis Mittanck, Springville, UT (US)

(21) Appl. No.: 18/194,146

(22) Filed: Mar. 31, 2023

Related U.S. Application Data
(60) Provisional application No. 63/325,995, filed on Mar. 31, 2022.

(51) Int. Cl. E06C 1/397; E06C 1/393

(52) U.S. Cl. CPC E06C 1/397; E06C 1/393

(57) ABSTRACT

Platform systems can support a user at an elevated position while being drivable or mobile via wheels and a drive system. Rail assemblies can be folded or collapsed so that the platform system can be carried by a user from one location to another. Hand controls are operable by the user from the elevated position to move the platform systems across a ground surface and can have automatic braking capability. Each side of the platform system can be independently driven, thereby allowing zero point turning and other fine control maneuvers. Structures at the base of the platform system can limit or prevent tipping or tilting. A cage system can help keep a user on the platform(s). Platforms can be collapsed or stowed with the rest of the platform system.

### CROSS REFERENCE TO RELATED APPLICATIONS

This application claims priority to U.S. Provisional Patent Application No. 63/325,995, filed 31 Mar. 2022, the entire disclosure of which is hereby incorporated by reference.

### TECHNICAL FIELD

The present disclosure generally relates to mobile platforms, scaffolds, ladders, and similar structures used to support users at elevated positions.

### BACKGROUND

Workers in the fields of construction, maintenance, repair, lighting, outdoor events, and other industries often need to access areas only reachable by a scaffold, ladder, or similar structure. These areas are not always near each other or are too large to be easily reached from a single platform in a single position, so the user either needs to use a very large platform, needs to use multiple platforms, or needs to move one or more platforms from place to place to access every area of interest. Generally, these platforms are movable from one place to another when disassembled or when a person is not positioned on the platform, but the reconfiguration of the platform and climbing up and down from the platform is potentially time consuming, dangerous, tiring, and/or requires multiple workers.

In many cases, the platforms are motorized (e.g., using electric motors to drive wheels at the base or to raise and lower a scissor-mechanism-supported platform), so the platform cannot function without external power sources, batteries, or fuel. They may also carry components having sizes or weights that make it impossible for a single person to move the platform up stairs or past other obstacles. In any case, these platforms are typically too unwieldy, heavy, complex, expensive, and/or niche for all but large institutional consumers. Accordingly, there is a constant need for improvements to mobile platforms.

### SUMMARY

One aspect of the present disclosure relates to a drivable platform, comprising: a first rail having a bottom end; a first wheel positioned at the bottom end of the first rail, the first wheel being coupled with a first driver; a second rail having a bottom end; a second wheel positioned at the bottom end of the second rail, the second wheel being coupled with a second driver; a first control assembly coupled with the first rail above the bottom end and including a first handle and a third driver; a second control assembly coupled with the second rail above the bottom end and including a second handle and a fourth driver; a first transmission member configured to couple rotation of the first driver and the third driver; a second transmission member configured to couple rotation of the second driver and the fourth driver; and a platform coupled to the first rail and the second rail. The first handle can be rotatable to drive rotation of the first wheel and the second handle is rotatable to drive rotation of the second wheel; and the first wheel can be rotatable independent of the second wheel.

In some embodiments, the first control assembly includes a crank coupled with the third driver and with the first handle. The first wheel can be rotatable in an opposite direction from the second wheel by operation of the first and second control assemblies. At least the first transmission member can comprise a chain engaging with a set of teeth on the first driver and with a set of teeth on the third driver. At least the first transmission member can comprise a belt engaging the first driver and the third driver. The platform can further comprise a brake coupled with at least one of the first and second rails, with the brake being rotatable to a position braking movement of at least one of the first and second transmission members. At least one of the first and second handles can automatically brake rotation of at least one of the third and fourth drivers.

Another aspect of the disclosure relates to a driving apparatus for a mobile platform, comprising: a rail; a drive system extending from a bottom end of the rail to a position above the bottom end of the rail; a wheel connected to the drive system at the bottom end of the rail; a crank arm rotatably coupled to a portion of the drive system at the position above the bottom end of the rail; and a handle coupled to the crank arm and movable between a first position and a second position relative to the drive system. With the handle in the first position, a brake can limit rotation of the crank arm, and with the handle in the second position, the brake can be released, and the crank arm can be rotatable to drive the drive system.

The handle can be biased to the first position. The handle can be rotatable between the first position and the second position within a plane intersecting an elongated dimension of the crank arm, with the first position being angularly offset from the second position. The handle can be translatable perpendicular to an elongated dimension of the crank arm to move between the first position and the second position. The handle can be translatable parallel to an elongated dimension of the crank arm to move between the first position and the second position. The brake can comprise a pin movable between a braking position engaging a plate of the drive system while the handle is in the first position and a released position spaced away from the plate while the handle is in the second position. The plate can radially extend relative to an axis of rotation of the crank arm. The brake can be released by rotating the handle from the first position to the second position.

In yet another aspect of the disclosure, a wheeled platform can comprise a first assembly including: a first pair of spaced apart rails; at least one rung extending between and coupled to the first pair of spaced apart rails; a first pair of wheels coupled to respective bottom ends of the first pair of spaced apart rails; and a first pair of hinge portions coupled to the first pair of spaced apart rails. The platform can also include a second assembly including: a second pair of spaced apart rails; a second pair of wheels coupled to respective bottom ends of the second pair of spaced apart rails; and a second pair of hinge portions coupled to the second pair of spaced apart rails. The first pair of hinge portions and the second pair of hinge portions can be coupled to each other to form a pair of pivotable hinges movable between a first position in which the first pair of rails extends at a non-parallel angle relative to the second pair of rails and a second position in which the first pair of rails extends parallel to the second pair of rails. The wheeled platform can also include at least one platform coupled with and extending between the first assembly and the second assembly below the pair of pivotable hinges.

In some embodiments, the at least one platform can include a first platform coupled with the first assembly and with a second platform, with the second platform being coupled with the second assembly. The first platform can be coupled with the second assembly.

A drive system can be included which includes: a rotatable handle at an upper end of at least one of the first and second assemblies, and a drive link configured for transferring a torque applied to the rotatable handle to at least one wheel of the first pair of wheels or at least one wheel of the second pair of wheels. The at least one platform can be pivotable relative to the first and second assemblies. Additionally, at least the pair of spaced apart rails may be adjustable between a first length configuration and a second length configuration, with the first length configuration being shorter than the second length configuration. A spacer bar system may be included which extends between a bottom end of the a rail of the first pair of spaced apart rails and a bottom end of a rails of the second pair of spaced apart rails, with the spacer bar system having an adjustable length.

The above summary of the present invention is not intended to describe each embodiment or every implementation of the present invention. The figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a perspective view of a platform system in an open or standing configuration.

FIG. 2 is a perspective view of the platform system of FIG. 1 in a collapsed or closed configuration.

FIG. 3 is a side section view as taken through section lines 3-3 in FIG. 1.

FIG. 4 is a side section view as taken through section lines 4-4 in FIG. 2.

FIG. 5 is a partial perspective view of drive system components of the platform system of FIG. 1.

FIG. 6 is a perspective view of a brake apparatus in an unlocked configuration.

FIG. 7 is an end view of the brake apparatus installed on a rail and in a locked configuration with a chain locked in place by the brake apparatus.

FIG. 8 is an exploded perspective view of the brake apparatus of FIG. 6.

FIG. 9 is an exploded perspective view of the brake apparatus of FIG. 6.

FIG. 10 is a perspective view of a hand control apparatus for use with a drivable platform system.

FIG. 11 is an end view of the hand control apparatus of FIG. 10.

FIG. 12 is a section view of the hand control apparatus as taken through section lines 12-12 in FIG. 11.

FIG. 13 is a perspective view of a hand control apparatus.

FIG. 14 is a section view of the hand control apparatus of FIG. 13 as taken through section lines 14-14 in FIG. 13.

FIG. 15 is a perspective view of a hand control apparatus and rail portion.

FIG. 16 is an end view of the hand control apparatus and rail portion of FIG. 15.

FIG. 17 is a section view of the hand control apparatus as taken through section lines 17-17 in FIG. 16.

FIG. 18 is a section view of the hand control apparatus in a locked configuration as taken through section lines 18-18 in FIG. 17.

FIG. 19 shows the hand control apparatus of FIG. 18 in an unlocked configuration.

FIG. 20 shows a section view of the hand control apparatus as taken through section lines 20-20 in FIG. 17.

FIG. 21 shows a perspective view of a hand control apparatus and rail portion.

FIG. 22 shows a section view of the hand control apparatus in a locked configuration as taken through section lines 22-22 in FIG. 21.

FIG. 23 shows the hand control apparatus of FIG. 22 in an unlocked configuration.

FIG. 24 shows a perspective view of a hand control apparatus and rail section.

FIG. 25 shows a section view of the hand control apparatus in a locked configuration as taken through section lines 25-25 in FIG. 24.

FIG. 26 shows the hand control apparatus of FIG. 25 in an unlocked configuration.

FIG. 27 shows a perspective view of a hand control apparatus.

FIG. 28 shows an exploded perspective view of the hand control apparatus of FIG. 27.

FIG. 29 shows an exploded perspective view of the hand control apparatus of FIG. 27.

FIG. 30 shows a partial section view of the hand control apparatus of FIG. 27 in a locked configuration as taken through the plane 30 shown in FIG. 27.

FIG. 31 shows the hand control apparatus of FIG. 30 in an unlocked configuration.

FIGS. 32A-32C show views of a cavity within the crank arm of the hand control apparatus of FIG. 27 with protrusions or teeth in different positions shown in broken lines.

FIG. 33 is a partial perspective view of a platform system having a skirt support system and wheel shrouds.

FIG. 34 is a side view of the platform system of FIG. 33.

FIG. 35 shows a perspective view of the platform system of FIG. 33 with the skirt support system in a stowed or collapsed configuration and with a platform of a platform assembly in a deployed configuration.

FIG. 36 shows a perspective view of the platform system of FIG. 33 with the skirt support system in a stowed or collapsed configuration and with a platform of the platform assembly in a stored or collapsed configuration.

FIG. 37 is a perspective view of a platform system.

FIG. 38 is a right side view of the platform system of FIG. 37.

FIG. 39 is a front view of the platform system of FIG. 37.

FIG. 40 is a perspective view of an upper end of the platform system of FIG. 37 at a hand control.

FIG. 41 is a right side view of the upper end of the platform system of FIG. 37 with internal gearbox components exposed.

FIG. 42 is a perspective view of a lower end of the platform system of FIG. 37 at a wheel.

FIG. 43 is an exploded view of the lower end of the platform system of FIG. 42.

FIG. 44A is a front section view of the wheel of FIG. 42 with a locking mechanism in a locked state relative to the wheel.

FIG. 44B is a front section view of the wheel of FIG. 42 with a locking mechanism in a first unlocked state relative to the wheel.

FIG. 44C is a front section view of the wheel of FIG. 42 with a locking mechanism in a second unlocked state relative to the wheel.

FIG. 45A is a perspective view of a spacer bar system of the platform system of FIG. 37 in a locked state.

FIG. 45B is a side section view of the spacer bar system of FIG. 45A.

FIG. 46A is a perspective view of the spacer bar system of FIG. 45A in an unlocked state.

FIG. 46B is a side section view of the spacer bar system of FIG. 46A.

FIG. 47 shows the platform system of FIG. 37 in an extended state.

FIG. 48 is a left side view of the platform system of FIG. 47.

FIG. 49 is a perspective view of an embodiment of a wheeled platform system.

FIG. 50 is a partially exploded view of the wheeled platform system of FIG. 49.

FIG. 51A is a side section view, as taken through section lines 51-51 in FIG. 49, of the wheeled platform system of FIG. 49 in a first configuration.

FIG. 51B is a side section view, as taken through section lines 51-51 in FIG. 49, of the wheeled platform system of FIG. 49 in a second configuration.

FIG. 51C is a side section view, as taken through section lines 51-51 in FIG. 49, of the wheeled platform system of FIG. 49 in a third configuration.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Various embodiments of devices usable in place of or as platforms, scaffolds, ladders, and related components and alternatives are described herein. The described embodiments are not mutually exclusive of each other. Rather, various features, components or elements of one described embodiment may be used in conjunction with features, components or elements of other described embodiments.

As mentioned above, conventional mobile lifts and platforms are too large, heavy, expensive, and potentially dangerous to use for certain tasks. Embodiments of the present disclosure relate to a mobile wheeled platform systems that are light and, in some embodiments, capable of being moved and deployed by a single person through narrow passages, up and down stairs, over debris and barriers, and to many places that a ladder would be used. The systems can be collapsible and thereby selectively capable of being used in a standing configuration or a flattened, collapsed configuration that saves storage space, makes the platform easier to carry and move from place to place, and is rugged, easy to use, fast to set up and take down, and otherwise immediately operable by everyday users.

The systems can be configured with platforms that collapse and deploy with the rail assemblies (or independently) to provide an elevated standing surface that permits a user to reach a wide area above the base of the system while also being surrounded by a set of bars, gates, or railings that help the user keep their balance and avoid or prevent falls. In some embodiments, multiple different platform levels are selectable by the user, whether by the user choosing to stand on one of multiple different deployed platform levels or by the user deploying one or more platforms from the rail assemblies at a desired platform level.

Various embodiments include wheels that allow the system to be easily and quickly moved through a flat work area surface such as across indoor flooring or pavement. A user positioned on one of the elevated platforms can operate a drive system configured to drive at least one of the rear wheels and to thereby move the platform without having to climb down the rungs, reposition the assembly, and re-climb up the rungs in a tiresome manner. In some embodiments, the drive system includes cranks or rotatable handles that the user can rotate to drive the wheels via a drive mechanism such as a transmission member or transmission linkage, such as, for example, a loop (e.g., a chain, belt, or other flexible transmission member), a drive shaft or other rigid transmission member, or a drive linkage or other assembly of flexible and/or rigid parts configured for transferring rotation of the handles to rotation of the wheels. See, e.g., transmission gears 3756 and 3770 of platform system 3700.

Furthermore, the drive system can have independently operable wheel drives, wherein each wheel can be independently rotated, thereby giving the platform system superior mobility, maneuverability, and ease of use. While on a work platform, the user can perform zero-point turns with the drive system(s), thereby allowing the system to move through tight spaces (e.g., near walls, in hallways, or around debris).

Various mechanisms can be implemented as part of embodiments of the drive systems that can be used to brake or otherwise prevent movement of the handles, loops, or wheels. In some cases, the brakes are automatic, wherein when a user stops operating a handle, the handle is biased into a configuration that prevents further rotation without user intent. In some cases, the brakes are configured to prevent movement of the loop(s) irrespective of inputs provided to the handles or wheels.

The platform systems can also include deployable/collapsible “skirt” bars or supports that extend between front and rear rail assemblies and that help to stabilize the platform system by engaging the ground surface in the event that one or more wheels drops below the surface level of the other wheels. Furthermore, one or more of the wheels can include shrouds or other protective barriers configured to limit the size of objects that can engage the curved sides/tread portions of the wheels, thereby limiting the platform system's ability to potentially engage large enough objects to cause it to tilt or tip over while the user operates the drive system.

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

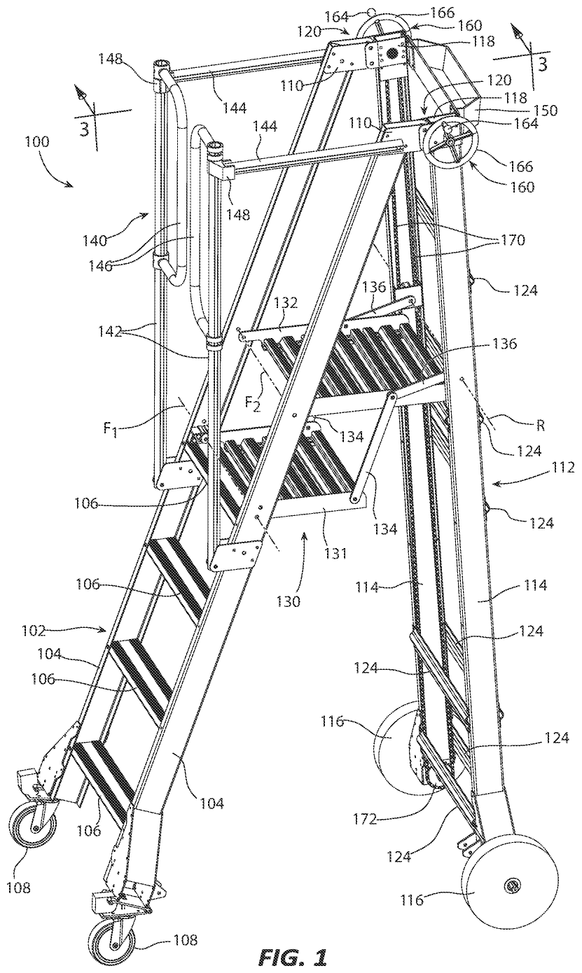

FIG. 1 is a perspective view of a platform system 100 of an embodiment of the present disclosure shown in a standing configuration (i.e., a user-supporting configuration or a non-parallel-rail configuration). The system 100 can include a first assembly 102 (i.e., a front assembly or platform entrance assembly) including a first pair of spaced apart rails 104 (i.e., a front pair of rails), a set of rungs 106 (i.e., front rungs, user-climbable steps, or foot-bracing members) extending between and coupled to the first pair of spaced apart rails 104, a first pair of wheels 108 coupled to respective bottom ends of the first pair of spaced apart rails 104, and a first pair of hinge portions 110 coupled with top ends of the rails 104.

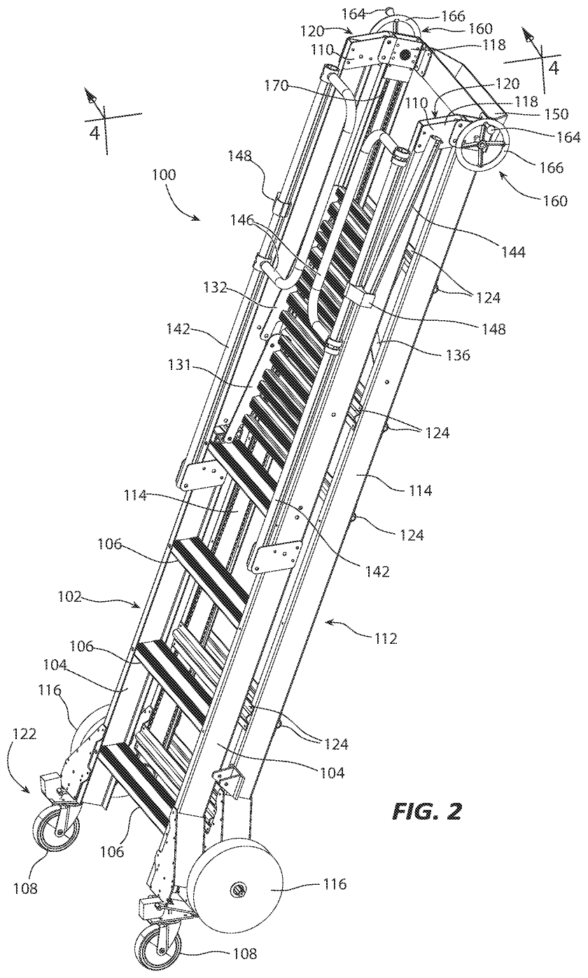

The system 100 can also include a second assembly 112 pivotally coupled with the first assembly 102 and including a second pair of spaced apart rails 114, a second pair of wheels 116 coupled to respective bottom ends of the second pair of rails 114, and a second pair of hinge portions 118 coupled to the second pair of spaced apart rails 114. The first pair of hinge portions 110 and the second pair of hinge portions 118 are coupled to each other to form a pair of pivotable hinges 120 movable between a first position in which the first pair of rails 104 extends at a non-parallel angle relative to the second pair of rails 114 and a second position in which the first pair of rails 104 extends parallel to the second pair of rails 114. An example first position of the hinges 120 is shown in FIG. 1, and an example second position is shown in FIG. 2, wherein the rails 104, 114 are parallel and positioned with their bottom and top ends adjacent to each other at about an equal distance relative to the position of FIG. 1.

The position shown in the perspective view of FIG. 2 can be referred to as a collapsed position, a storage position, a flattened position, a carrying position, or a folded position. The platform system 100 can be grasped by the user and carried with the rails 104, 114 being substantially horizontal, or the system 100 an be tilted and rolled from place to place on at least two of the wheels (e.g., pairs of wheels 108 or 116). Thus, while in the collapsed position, the system 100 can be supported at the bottom end 122 by one pair of the wheels and can be supported above the bottom end 122 by a user holding onto the rails 104 or 114, rungs 106, or other graspable elements of the system 100. Accordingly, much of the weight of the system 100 can be borne by the wheels rather than by the user as it is moved from place to place, thereby improving mobility and ease of repositioning the system 100. Furthermore, the rails 104, 114 and other structural components of the system 100 (e.g., the rungs 106) can comprise lightweight materials such as fiberglass, plastic, or aluminum, thereby minimizing weight and improving portability of the system as a whole, especially if the user needs to lift the entire system from the floor from time to time and wheel support is not provided in those moments. Weight reduction can also reduce shipping and manufacturing costs to enable lower transportation and building costs to makers and users of the system. The platform system 100 can be operated similar to a ladder, wherein a user can easily scale the rungs 106 while grasping the rails 104, and the rails 114 (i.e., the rear rails) of the second assembly 112 (i.e., the rear assembly) can be supported by rungs or brace members (e.g., braces 124) to provide a rigid frame to support the weight of users and tools.

In some embodiments, at least one platform assembly 130 (i.e., a platform structure or full-foot user support surface) is coupled with and extends between the first assembly 102 and the second assembly 112 below the pair of pivotable hinges 120. The platform assembly 130 can include a first platform 131 coupled with the first assembly 102 and a second platform 132 coupled with the second assembly 112. The platforms 131, 132 can be coupled to each other as well. In platform system 100, the first platform 131 is pivotally coupled with the front rails 104 across a front platform pivot axis F₁, and the second platform 132 is pivotally coupled with the front rails 104 across a second front platform pivot axis F₂. The second platform 132 is not directly pivotally coupled with the rear rails 114, and is instead connected to the rear rails 114 via a pair of linkage arms 136 at a rear platform pivot axis R. See FIG. 1. Each platform 131, 132 can be made of a set of extrusions or bars that collectively act as a support for larger objects such as a user's foot or a bucket while also allowing small objects or liquids to pass through the platforms. This hollow and slotted configuration can reduce weight and improve users' stability while they are on the platforms.

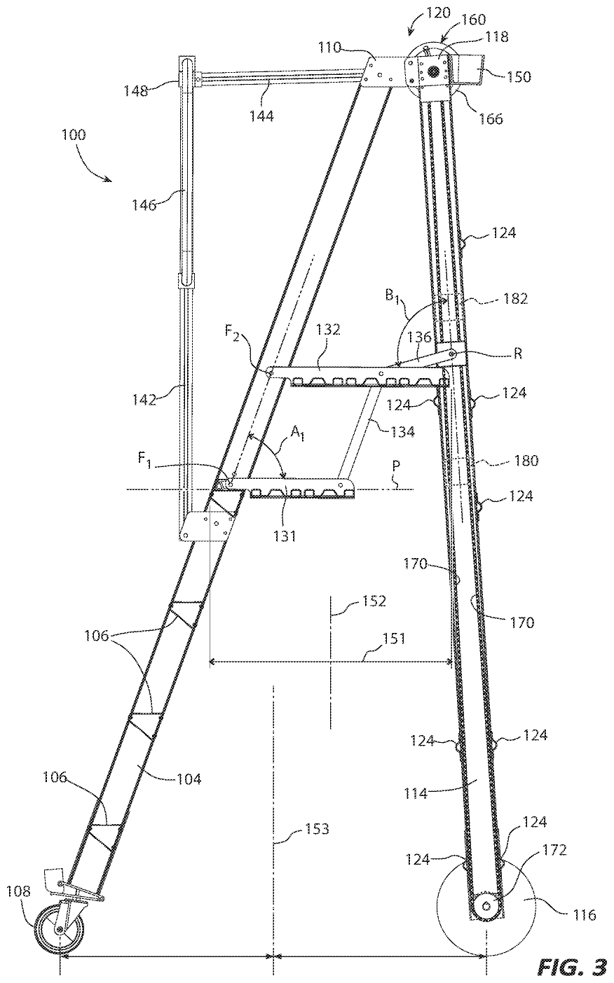

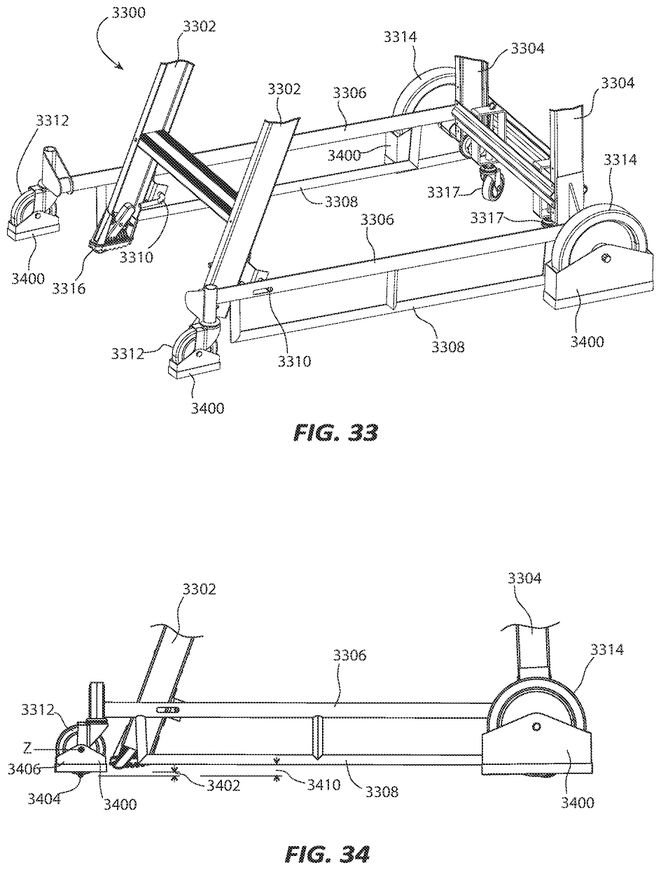

The first platform 131 can have a top support surface on at least roughly the same vertical level as the top-most rung 106 of the first assembly 102 when the system 100 is in the standing configuration, thereby causing the top support surfaces of the rung 106 and platform 131 to collectively support the same objects in the same support plane P (see FIG. 3). This can increase the overall support surface provided by that level of the system 100 relative to a ground support surface on which the wheels 108, 116 provide support for the rest of the system 100. A rung and platform of the platform system 3300 of FIGS. 33-36 can also provide this functionality.

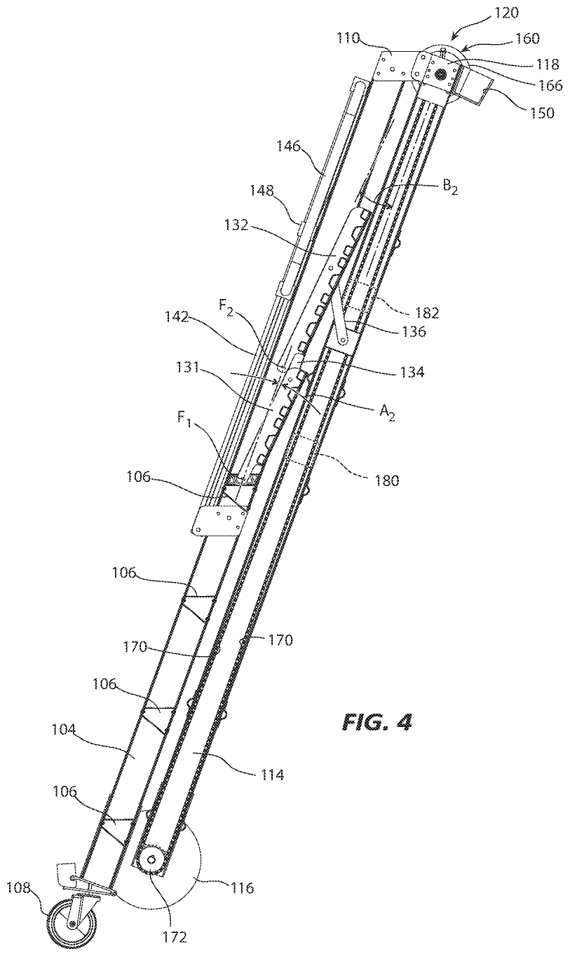

A pair of intermediate linkage arms 134 also pivotally couple the platforms 131, 132 with each other in a manner that causes the platforms 131, 132 to rotate from a horizontal support position in which the platforms 131, 132 are oriented at angles A₁ and B₁, respectively (shown in the central side cross-section of FIG. 3), to a storage or collapsed position in which the platforms 131, 132 are oriented at angles A₂ and B₂, respectively. Notably, the angles A₁/B₁ are larger than angles A₂/B₂, wherein when in the collapsed position, the support surfaces of the platform 131, 132 are much closer to being parallel to the longitudinal axes of the rails 104, 114 than in the deployed or user-supporting position. This can help to minimize the overall width profile of the collapsed platform system 100. The platforms 131, 132 do not need to be removed from the system 100 when it is collapsed, thereby reducing part counts and eliminating a burden on the user to keep track of different parts of the system. The platforms 131, 132 can both be configured to automatically deploy when the assemblies 102, 112 are pivoted at the hinges 120, thereby eliminating any need for the user to set up the platforms 131, 132 independent of the other parts of the system 100. These time-saving features can improve workplace efficiency, improve user experience, and reduce fatigue and accidents. The collapsed platforms 131, 132 can also be configured to lie between front and rear planes defined by front-most and rear-most surfaces of the first and second assemblies 102, 112 or defined by the first and second pairs of rails 104, 114, as shown in FIG. 4.

In some embodiments, the platform system 100 includes a deployable cage system 140 coupled to at least one of the assemblies (e.g., only to the first assembly 102 in system 100). The cage system 140 can comprise a pair of vertical strut assemblies 142 and a pair of horizontal strut assemblies 144 that enable collapsing of the cage system 140 to a configuration where the vertical strut assemblies have their bars parallel to, or substantially parallel to, the front rails 104 in a manner that minimizes the overall collapsed depth of the system 100 along its front-to-back dimension (i.e., perpendicular to the longitudinal axes of the rails 104 or perpendicular to a plane in which the rails 104 lie). To enable this collapsing movement, the cage system 140 can have movable or position-reconfigurable couplings (e.g., sliding couplings 148) that join the vertical strut assemblies 142 to the horizontal strut assemblies 144 and that can slide along the bars of the vertical strut assemblies 142 between a first position with the bars of the horizontal strut assemblies 144 being substantially horizontal (as shown in FIGS. 1 and 3) and a second position with the bars of the horizontal strut assemblies 144 being nearly parallel to the rails 104 or nearly parallel to the bars of the vertical strut assemblies 142 (as shown in FIGS. 2 and 4). In some embodiments, the couplings 148 can detach and reattach to convert between the deployed and collapsed configurations. The vertical strut assembles 142 can pivot at their connection brackets to the front rails 104 to become parallel to the front rails 104.

Additionally, a set of gate members 146 can be rotatably joined to the pair of vertical strut assemblies 142 in a manner allows the gate members 146 to rotate to an open position in which a user can pass between the gate members 146 and onto the platforms 131, 132 and a closed position in which passage between the vertical strut assemblies 142 is limited by physical interference of the gate members 146. The gate members 146 can be configured with biasing features that bias them into the closed configuration so that a user positioned on the platforms 131, 132 can use the gate members 146 as a hand or body support, but the user can also apply a torque to the gate members 146 to move them out of the way when he or she is climbing or descending the first assembly 102.

The intermediate linkage arm 134 can be connected to an end of the first platform 131 that is spaced away from the front rails 104 and can, by its connection to the second platform 132 and second linkage 136, suspend the first platform 131 horizontally and at a level substantially equal to the height of the front platform axis of rotation F₁. As the rails 104, 114 move to the collapsed position, the intermediate linkage arm 134 can help pivot and move the first and second platforms to their stowed/collapsed positions as a moment is applied to the intermediate linkage arm 134 by the second linkage 136 due to rotation of the rear rails 114 at the hinges 120.

In some embodiments, an upper rear railing or brace can extend across and connect the top ends of the rails 104, 114 at or near the hinges 120. In system 100, this brace is formed as a cargo container 150 that forms a trough or cup in which objects such as tools and fasteners can be supported and kept in a convenient position for easy and repeated access by a user. The brace can also serve as a barrier that limits the user's movement while on the platform(s) 131, 132 and acts as a cross-beam that helps prevent the user from moving too far between the rear rails 114. When in a standing configuration, the rear rails 114 can be arranged more vertically oriented than the front rails 104, thereby allowing the user to have easier access to areas immediately rearward from the platforms 131, 132. In other words, the work area in which the user can safely operate can have a horizontal range 151 (defined by the bounds of the platforms 131, 132 and topmost rung 106, i.e., the total standing surface enclosed by the cage system 140, hinges 120, and cargo container 150) that has a centerline 152 positioned rearward of the overall centerline 153 of the system 100 which is located centrally between the pairs of wheels 108, 116. This can help ensure that the center of gravity of the loaded system 100 (i.e., including user and tools on a platform 131, 132) can remain within the four corners of the system 100 to improve stability.

Additionally, using rear rails 114 that are more vertically oriented than the front rails 104 reduces the overall longitudinal length necessary for the rear rails 114 and therefore also reduces the overall length needed for the drive system(s) in the rear rails 114, such as the loops or longitudinal driveshaft components in the rear rails 114. A more vertically oriented set of rear rails 114 can also make the frame stiffer and can allow the front rails 104 to be at a more comfortable climbing angle (e.g., a more stair-like angle) for the rungs 106.

The platform system 100 can also include components that, when operated together, are usable as at least one drive system for the platform system and that enable movement of the platform system 100 while a user is standing on a platform 131, 132. The user can operate the drive system(s) to move the platform system 100 without need for another user's or operator's assistance, and the user can operate the drive system without having to descend from the platforms 131, 132. In other words, the user can move the platform system 100 while it is in the standing configuration using hand controls located at or near the top ends of the rails 104, 114, while standing in an elevated position within the horizontal range 151, and while being surrounded by the cage system 140 and brace/container 150.

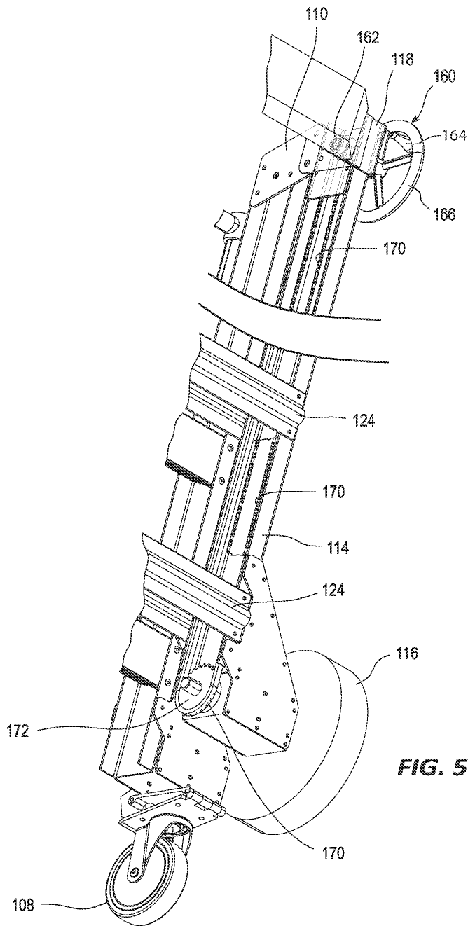

A pair of drive systems can include a respective pair of rotatable hand controls 160 rotationally linked to a pair of wheels, pulleys, or gears 162 pivotally coupled to an upper end of the rear rails 114. See FIG. 5. The upper wheels, pulleys, or gears 162 can be referred to as drivers, rotational links, or torque-transferring devices. In some embodiments, the hand controls 160 are positioned on a laterally outer side of the rails 114, and the gears 162 are positioned on a laterally inner side of the rails 114, as shown in system 100. Thus, the hand controls 160 can be easily accessed by a user whose hands are positioned on outer sides of the hinges 120, and rotation of the hand controls 160 can be unimpeded by other nearby structures of the platform system 100 such as the container 150.

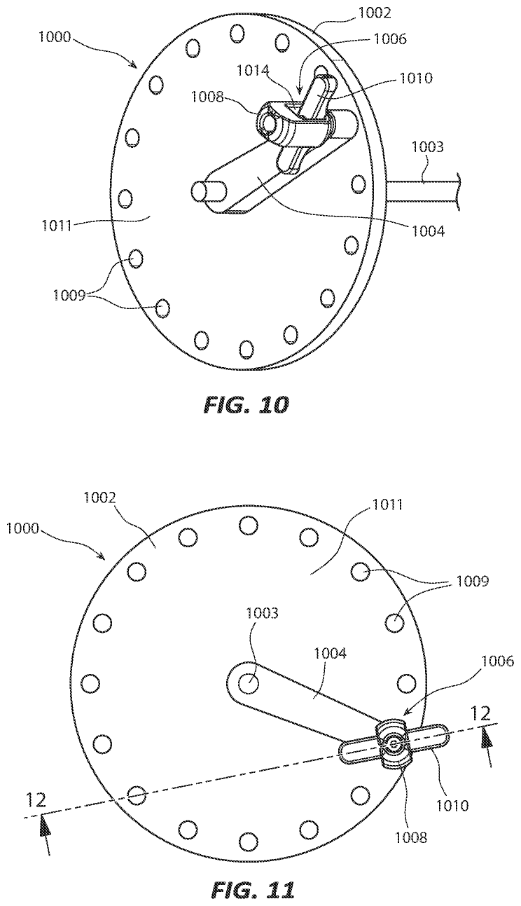

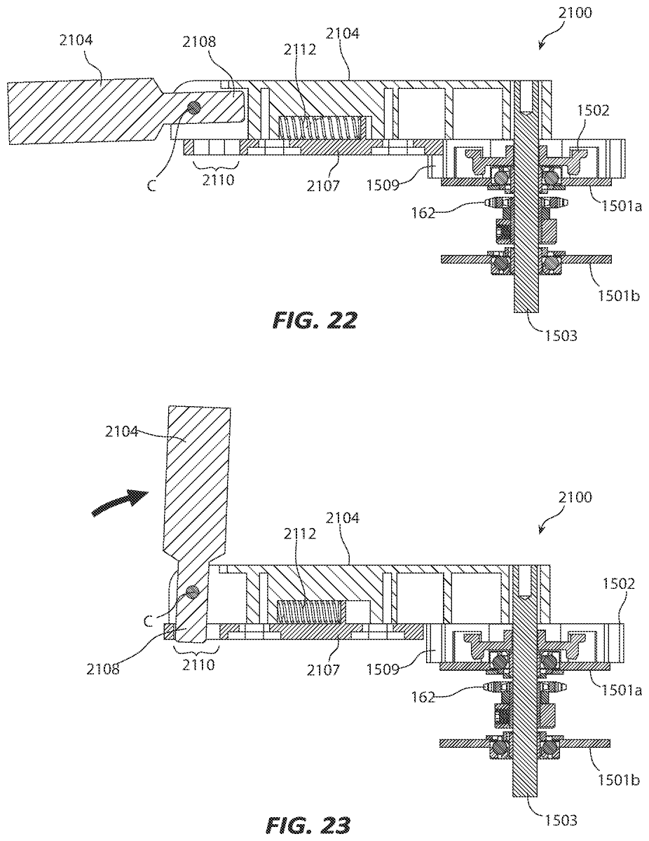

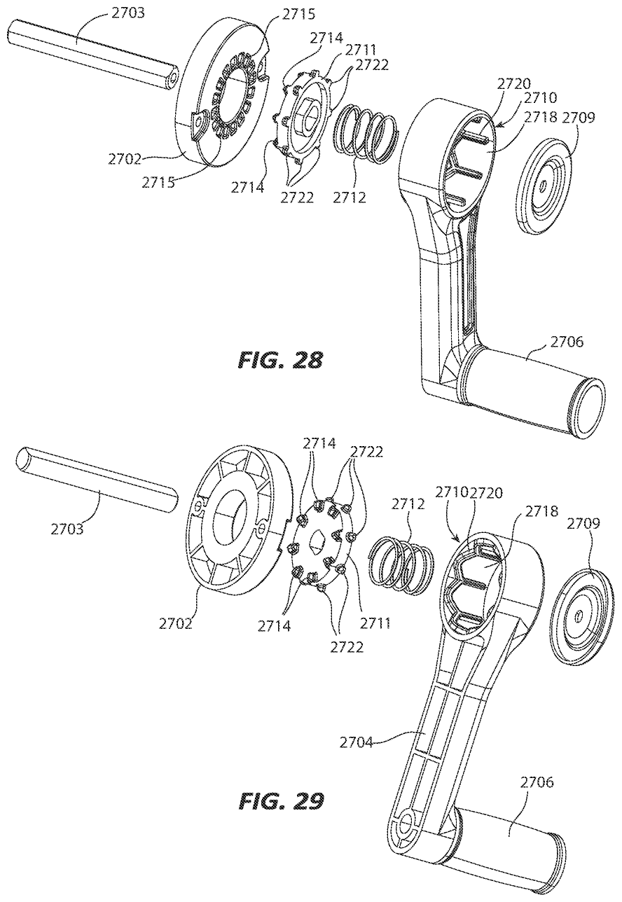

Each of the hand controls 160 can optionally include a lateral handle 164 or grip member that is pivotally (or non-pivotally) coupled with a cranking wheel 166. Thus, the axis of rotation of the gears 162 can be offset from an axis defined through the lateral handles 164. The handles 164 can rotate about the axis of rotation through the gears 162, but the cranking wheels 166 can offset the rotation of the handles 164, thereby creating a moment arm that improves the user's comfort and establishes a moment applied when cranking the handles 164. In some embodiments, the cranking wheels 166 can be a single crank arm or bar member joining a lateral driveshaft (located at the center of the wheel 166 and through the center of the corresponding gear 162) to a handle portion at the end of the arm or bar member. See also, e.g., FIGS. 10-32 which show various crank arm and hand control assemblies.

The gears 162 can comprise sprockets, toothed-circumference gears, high-friction wheels (e.g., rubber-lined wheels), angle gears, pulleys, other force-transferring elements or links, and related devices that transfer a moment/torque applied to a corresponding one of the pair of hand controls 160 to a respective loop of a pair of loops 170, longitudinal driveshafts, or other longitudinal force transferring devices engaged with the gears 162 and extending primarily longitudinally along (and, in some cases, at least partially within) the rear rails 114 to a corresponding one of a pair of lower gears 172 at the base of the rear rails 114.

The lower wheels or gears 172 can be referred to as drivers, rotational links, or torque transferring devices. The drive systems include two sides or drive assemblies that are mirror-images of each other, and any reference to a single upper gear 162, loop 170/longitudinal driveshaft, or lower gear 172 can apply to both sides of the platform system 100. Similarly, the hand controls 160 can be mirror images of each other, and descriptions herein about one hand control can be applied to both of them.

In some embodiments, each side of the drive system can be identical, such as by using the same type of gears 162, 172, loop 170, hand controls 160, and wheels 116 on each side, and in some embodiments, one or more components on each side can be different, such as by using different hand controls 160 on each side or using a loop 170 on one side and a longitudinal driveshaft instead of a loop 170 on the opposite side. Accordingly, the various parts of the various embodiments of the drive systems of the present disclosure can be fit together in a variety of combinations that will be apparent to those having skill in the art and the benefit of the present disclosure.

A loop 170 can include at least one chain, belt, band, rope, cable, or similar flexible member that transfers rotation of an upper gear 162 to rotation of a lower gear 172. The loop 170 can be configured to be bendable while having minimal elastic longitudinal stretching characteristics in order to diminish slop in the loop 170 and to more closely synchronize the rotations of the gears 162, 172. Using a chain, belt, or band with holes which receive teeth of the gears 162, 172 can beneficially reduce slippage of the loop 170 and also help transfer forces between the gears 162, 172 and the loop 170. In some embodiments, the loop 170 comprises a roller chain (i.e., a bicycle chain) configured to receive and engage rounded sprocket teeth of the gears 162, 172. In some embodiments, the loop 170 can comprise teeth (i.e., a tooth chain or inverted tooth conveyor chain) configured to engage openings in the gears 162, 172.

A longitudinal driveshaft can be used in place of the loop 170, such as a bar or tube having toothed/geared ends that respectively engage the upper and lower gears 162, 172. For example, a longitudinal driveshaft can include angled gear surfaces (or can be affixed to angled gears) that engage angled teeth of the upper and lower gears 162, 172. A longitudinal driveshaft can more efficiently transfer torque between the gears 162, 172 and can have less slop/wobble at the lower gear 172 as compared to a chain. In some embodiments, a longitudinal driveshaft can be included with telescoping capability, wherein the length of the driveshaft is adjustable or tunable when installed in different rails (e.g., front rails versus rear rails that have substantially different lengths by design or in different rear rails that each have different lengths due to dimensional or assembly tolerances/variance). Thus, the longitudinal driveshaft can in some cases include at least two portions with one portion capable of being coupled to the second portion in at least two different longitudinal positions, thereby granting the overall driveshaft at least two different possible longitudinal lengths. This can be especially useful to tune the length of the longitudinal driveshaft so that its end portions with teeth or other engagement features properly mesh or otherwise engage drivers (e.g., gears 162, 172) at its extreme ends.

Rotation of the lower gears 172 can cause rotation of the rear wheels 116. Thus, the rear wheels 116 can be referred to as drive wheels or primary driven wheels of the platform system 100. By cranking the handles 164, the rear wheels 116 can be rotated due to rotation of a lateral driveshaft connecting each lower gear 172 its respective rear wheel 116 on the lateral outside of the rail 114, thereby giving the platform system 100 mobility and giving the user the ability to reposition the platform system 100 while standing on the platform of the system 100.

Rotation of each handle 164 can drive the speed and direction of rotation of each respective wheel 116. For example, as viewed from a single side of the platform system 100, clockwise rotation of the left hand control 160 can cause corresponding clockwise rotation of the left rear wheel 116, and vice versa for counterclockwise rotation of the left hand control 160. Turning the right hand control 160 in the same direction and at the same speed as the left hand control 160 can drive the platform system 100 rearward (i.e., with the “front” wheels 108 trailing behind the “rear” wheels 116). Turning the hand controls 160 in the same direction at different speeds can cause the platform system 100 to veer to the left or right as it moves rearward (or forward). Operating one hand control 160 while leaving the other stationary can cause the platform system 100 to pivot about the stationary rear wheel 116. Operating one hand control 160 in a first direction while operating the other hand control 160 in the opposite direction can cause the platform system 100 to pivot about a point positioned on an axis extending between the rear wheels 116 on the support surface. If the hand controls 160 are driven at the same rotational speeds in the opposite directions, the platform system 100 is capable of performing a zero-point turn (i.e., a “tank turn” or “zero turn”) that rotates the platform system 100 about a pivot point positioned equidistant (i.e., at a midpoint) between the rear wheels 116 on the axis extending between them.

This degree of fine movement control can give the user freedom to move the platform system 100 carefully and directly to where it is needed. Accordingly, this can minimize the number of times the user feels inclined to lean sideways from the platforms 131, 132 to reach a desired work location rather than moving the platforms 131, 132 to a closer, less strenuous, or less dangerous position.

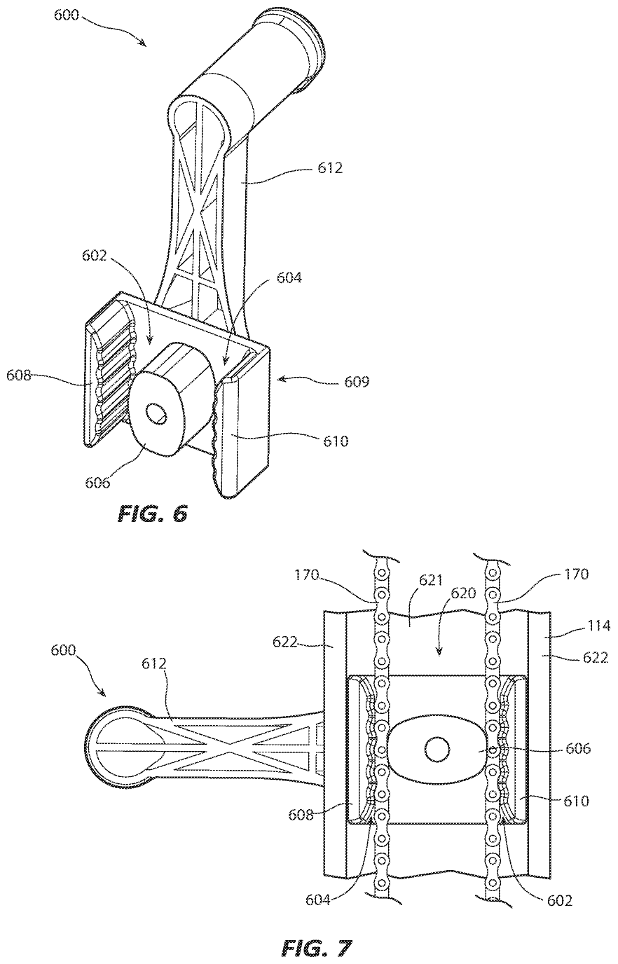

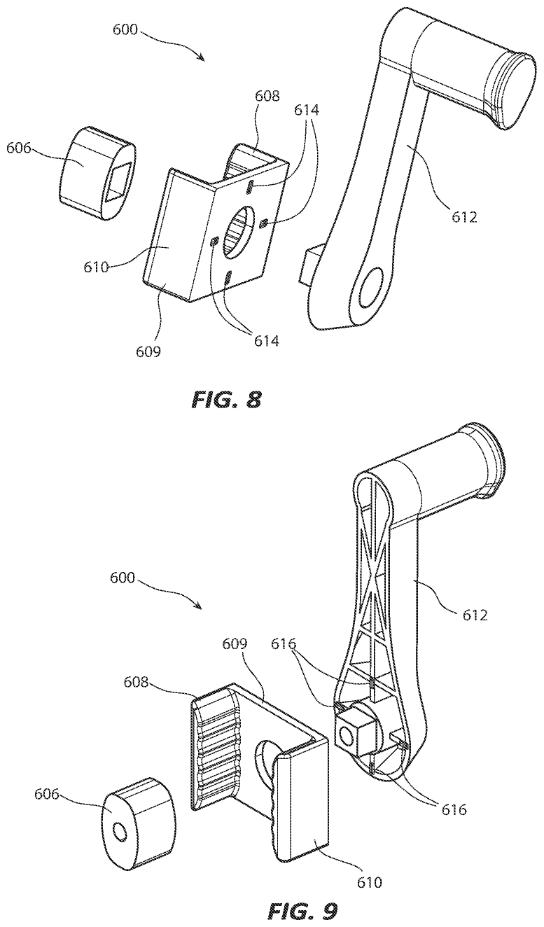

FIGS. 6-9 show an embodiment of a loop brake or chain brake 600 configured to be used in connection with a drive system having a loop 170 that transfers rotation between the upper and lower gears 162, 172. FIG. 6 shows a perspective view in a first, unlocked configuration, FIG. 7 shows an end view in a second, locked configuration, and FIGS. 8-9 show exploded views of the brake 600.

The brake 600 can be positioned in or on a rear rail 114. In some embodiments, the brake 600 can be positioned near a longitudinal midpoint of the rear rail 114 to which it is connected. In some embodiments, the brake 600 can be positioned above the support plane P defined by the first platform 131 (e.g., at position 180 in FIGS. 3-4) or above a plane defined by the second platform 132 when in the standing configuration (e.g., at position 182 in FIGS. 3-4), in which cases the brake 600 can be operated by a user's foot while he or she stands on the respective platform 131, 132. The brake 600 can also beneficially be positioned at a height along the longitudinal length of the rear rails 114 that also allows a user standing on the horizontal support surface (on which the wheels are supported) to reach and operate the brake 600 by hand (i.e., reaching up) without having to climb onto the platform system 100. For instance, the brake 600 can be positioned about halfway up the length of the rear rails 114 so that it is conveniently located for access whether the user is on the ground nearby or on a platform of the system 100.

The brake 600 can be used as a “parking” brake similar to one used in an automobile, wherein the brake 600 can be engaged or disengaged by the user to control whether (or at least how much) the loop 170 can move at the gears 162, 172 and can thereby control whether (or at least how much) the wheels 116 or hand controls 160 can rotate. The brake 600 can be attached to a laterally inner side of the rear rail 114 to avoid inadvertent bumps or collisions that could cause the brake 600 to accidentally disengage. A handle, arm, or grip of the brake 600 (e.g., 612) can extend through the rail 114 to a laterally outer position where it can be easily accessed and manipulated.

The brake 600 of FIGS. 6-9 can have at least one substantially longitudinally-extending length portion of a loop 170 positioned in at least one of a pair of channels 602, 604 in the brake 600 that are defined by sides of a central rotatable cam 606 and a pair of flanking outer walls 608, 610. The cam 606 can be rotationally coupled with a crank/crank arm or brake arm member 612 to turn the cam 606 relative to a bracket 609 bearing the walls 608, 610 as the arm member 612 is turned between a first, unlocked position shown in FIG. 6 and a second, locked position shown in FIG. 7. The bracket 609 can be mounted to (i.e., stationary relative to) the rear rail 114 on which the brake 600 is positioned.

As shown in FIGS. 8 and 9, a corresponding set of detents 614 and protrusions 616 on the bracket 609 and arm member 612 (or vice versa, in some embodiments) can help bias the movement of the arm member 612 relative to the bracket 609 into the locked or unlocked positions so that the arm member 612 moves about 90 degrees between those positions and is biased against inadvertent sliding out of the locked or unlocked position without a minimum user-applied moment or torque driving the rotation of the arm member 612 from one position to another. In some embodiments, other biasing mechanisms can be used in place of, or in addition to, the detents 614 and protrusions 616, such as biasing springs, ramps, cams-and-followers, or stop plates. In some embodiments, the brake 600 can implement a crank arm with a protrusion or pin that is positionable in an opening or recess of a plate, such as is shown in connection with the various hand controls disclosed herein.

While in the unlocked position, the channels 602, 604 each define a space or gap through which the portion(s) of the loop 170 can pass substantially freely and unrestricted by the brake 600. Thus, the loop 170 can be driven and transfer forces between the upper and lower gears 162, 172 without the brake 600 pinching or constraining the loop 170 while the brake is unlocked.

While in the locked position shown in FIG. 7, the channels 602, 604 are each reduced in their lateral widths because the large/elongated axis of the generally elliptical shape of the cam 606 rotates into a position generally perpendicular to the loop 170 portions, channels 602, 604, and walls 608, 610. This reduces the space through which the loop 170 can pass between the walls 608, 610 and the cam 606 and clamps or pinches in place any loop portion positioned in a channel 602, 604. The clamping or pinching prevents further sliding of the loop 170 through the brake 600 and thereby stops rotation of the gears 162, 172 (or at least prevents rotation of the gears 162, 172 in excess of the amount of stretching, slack, or longitudinal extension possible by the loop 170). Accordingly, the brake 600 can stop or significantly reduce the mobility of the platform system 100 while in the locked configuration. One or more brakes 600 can be positioned on one or both rails 114 to provide independent and supplemental stopping power to each side of the system 100 if needed.

The brake 600 shown in FIGS. 6-9 has enhanced stopping power for a loop 170 configured as a chain due to the walls 608, 610 having wavy, bumpy, undulating loop-facing surfaces configured to engage links of the chain when in the locked configuration. The protruding shapes of the wall surfaces can be received in recesses in the chain, as shown in FIG. 7. Thus, in order for the chain to longitudinally slip through the channel (e.g., 602), it would need to move radially inward (toward the center of the cam 606) or else the interlocking wave protrusions and chain recesses mechanically interfere with the movement of the chain. However, because the cam 606 tightly engages the opposite side of the chain, the chain is longitudinally immobilized in a manner with even more stopping power than a smooth wall 608 would provide by essentially just friction between the chain/loop and wall/cam.

Nevertheless, in some embodiments, the brake 600 can have smooth walls 608, 610 that face the loop 170 and form the channels 602, 604. Additionally, in some embodiments, the walls 608, 610 can be integrally formed with or part of the rail (e.g., 114) on which the brake 600 is formed. For example, the rear rail 114 can form a longitudinal channel 620 (e.g., a C- or U-shaped channel, as shown in FIGS. 1-2 and 7) in which the loop 170 extends, and the brake can comprise an arm member 612 and cam 606 positioned on opposite sides of the base wall 621 of the longitudinal channel. The front and rear sides 622 of the longitudinal channel (e.g., extending perpendicularly and laterally from the base wall 621 of the longitudinal channel) can be used as the walls 608, 610, so the loop 170 can be clamped between the cam 606 and the inner surface of the rail 114. In some embodiments, a bracket (e.g., 609) or plate can reinforce the inner surface of rail 114 where the brake 600 is operated.

As discussed in connection with FIGS. 1-5, the hand controls 160 can each include a cranking wheel 166 and a lateral handle 164 configured to drive a lateral driveshaft linking the cranking wheel 166 to the upper gear 162. In some embodiments, the hand controls 160 can include built-in, automatic braking or stopping mechanisms to help prevent unintentional rotation of the controls and corresponding movement of the platform system 100. At least one brake 600 and these automatic braking or stopping mechanisms can be used and implemented in the same platform systems.

FIGS. 10-12 show aspects of an embodiment of a hand control 1000 that can be used in place of one or both of the hand controls 160 of platform system 100. Features and aspects of the hand controls 160 can also be used in connection with hand control 1000. The hand control 1000 can include a plate 1002 (i.e., a lock plate, pin-receiving panel, or handle retainer plate) mounted at or near the top end of the rails (e.g., top end of rails 114 at hinges 120 or above platform support plane P) with a lateral driveshaft 1003. The plate 1002 can be configured to remain stationary relative to the rails as the hand control 1000 is operated, and the lateral driveshaft 1003 can rotate relative to the plate 1002 to drive a gear of the drive system (e.g., upper gear 162). The hand control 1000 can include a crank arm 1004 (i.e., a crank or moment arm separator) coupled with the lateral driveshaft 1003 and with a lateral handle assembly 1006. The user can grasp the lateral handle assembly 1006 to crank the crank arm 1004 and thereby rotate the lateral driveshaft 1003.

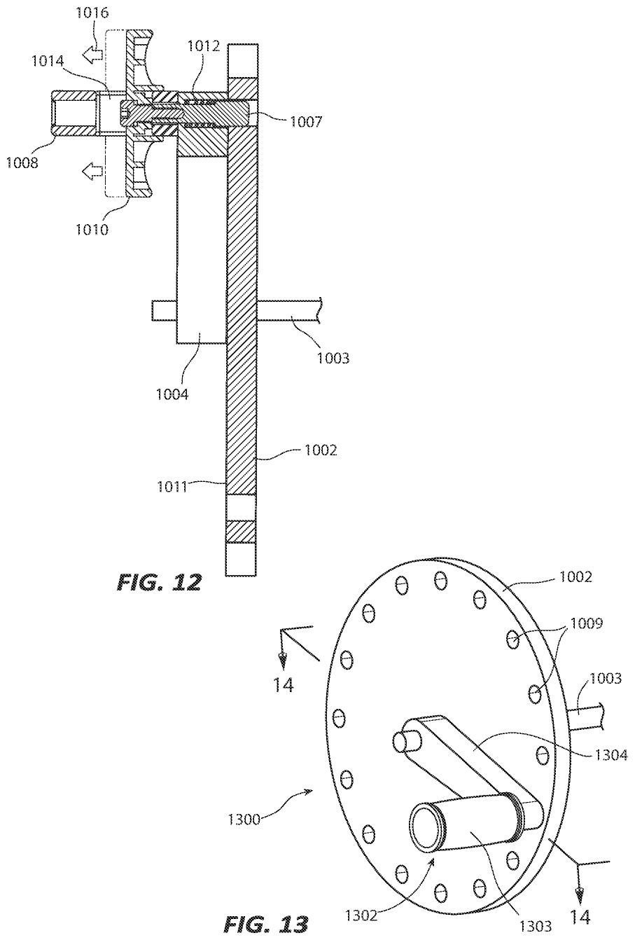

The lateral handle assembly 1006 can be pinned, locked, or otherwise reversibly rotationally retained to the plate 1002, and can thereby lock rotation of the lateral driveshaft 1003 relative to the rails, by a biased pin 1007 (see cross-section of FIG. 12 as taken through section lines 12-12 in FIG. 11) that is insertable into at least one of a set of circumferentially spaced openings 1009 in a surface 1011 of the plate 1002 that faces the crank arm 1004. Mechanical interference between the pin 1007 and the opening 1009 can lock the crank arm 1004 relative to the plate 1002 so that further rotation of the arm 1004, lateral driveshaft 1003, and lateral handle assembly 1006 is greatly limited or not possible. The pin 1007 can be biased into the locked position shown in FIG. 12 by a spring 1012 or similar biasing member positioned in the crank arm 1004, end handle housing 1008, or other parts of the lateral handle assembly 1006.

The lateral handle assembly 1006 (and the crank arm 1004 and lateral driveshaft 1003) can be unlocked or otherwise made rotatable relative to the plate 1002 by moving the pin 1007 from the locked position shown in FIG. 12 to an unlocked position that is withdrawn from the opening 1009. In order to do so, a user can pull a grip member 1010 of the lateral handle assembly 1006 that is affixed to the pin 1007 along a longitudinal axis of the pin 1007 within a channel 1014 in the end handle housing 1008, as indicated by the arrows 1016 in FIG. 12. When doing so, the force applied to the grip member 1010 can overcome the biasing force applied by the spring 1012 and can free/withdraw the pin 1007 from the opening 1009, thereby enabling rotation of the crank arm 1004 and driveshaft 1003 while the pin 1007 remains outside the openings 1009.

For continuous drive rotation of the crank arm 1004, a user can compress the lateral handle assembly 1006 by laterally pulling the grip member 1010 and can hold pressure on the grip member 1010 (e.g., by placing his or her fingers around the grip member 1010 and placing his or her palm on the end handle housing 1008, then squeezing the grip member 1010 laterally outward). The user's fingers applying the unlocking force to the grip member 1010 may be at least partially oriented parallel to the longitudinal axis of the pin 1007/opening 1009. The pressure on the lateral handle assembly 1006 can be maintained while cranking the arm 1004 until a desired position of the platform system 100 has been reached (so that the pin 1007 does not re-engage the openings 1009 while moving). At that point, the user can release the grip member 1010, thereby allowing the spring 1012 to urge the pin 1007 back toward the face 1011 of the plate 1002. Rotation of the arm 1004 from that point can continue only until the pin 1007 is re-seated into one of the openings 1009, at which position the hand control 1000 returns to a locked configuration. The spacing and positioning of the openings 1009 can therefore correspond to a plurality of different locked positions for the pin 1007, such as the sixteen positions shown in FIGS. 10-11. Using a high number of locking positions can limit the amount of unlocked rotation of the crank arm 1004 that is possible before reaching a seated/locked position.

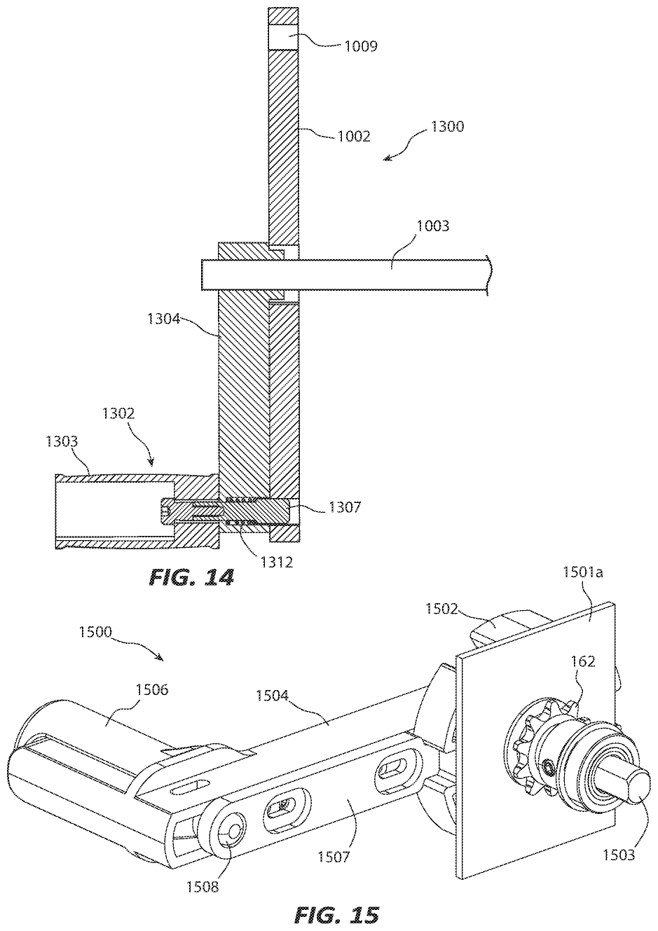

FIGS. 13-14 illustrate aspects a hand control 1300 that can be used with platform systems described herein and that has elements in common with hand control 1000. In this hand control 1300, a lateral handle assembly 1302 has a handle portion 1303 generally cylindrical rather than being generally t-shaped (as in lateral handle assembly 1006). Thus, a user can grip the handle portion 1303 and can pull the pin 1307 out of the opening 1009 (thereby overcoming biasing force applied by spring 1312) to enable rotation of the crank arm 1304 and driveshaft 1003. In other words, the handle portion 1303 can be withdrawn along a longitudinal axis of the pin 1307 or the opening 1009 in a direction parallel to the axis of rotation of the driveshaft 1003 while the user's fingers applying the unlocking force to the handle 1303 are wrapped circumferentially around the handle portion 1303.

FIGS. 15-20 show aspects of a hand control 1500 that can be used with platform systems described herein. In this hand control 1500, a plate 1502 can have a set of circumferential openings 1509 that open radially, similar to recesses between gear teeth. Thus, the plate 1502 can be referred to as a gear plate or a locking gear retainer. The plate 1502 can be affixed to and rotationally stationary relative to the rails of the platform system (e.g., at rail walls 1501a/1501b shown in FIGS. 15-17, which can represent portions of a rear rail 114). A crank arm 1504 can be coupled, at a radially inner first end, with a lateral driveshaft 1503 and upper gear 162, as shown in FIGS. 15 and 17. The crank arm 1504 can be coupled with a squeezable grip member 1506 at an opposite, radially outer second end. The grip member 1506 can extend laterally outward and substantially parallel to the axis of rotation of the lateral driveshaft 1503.

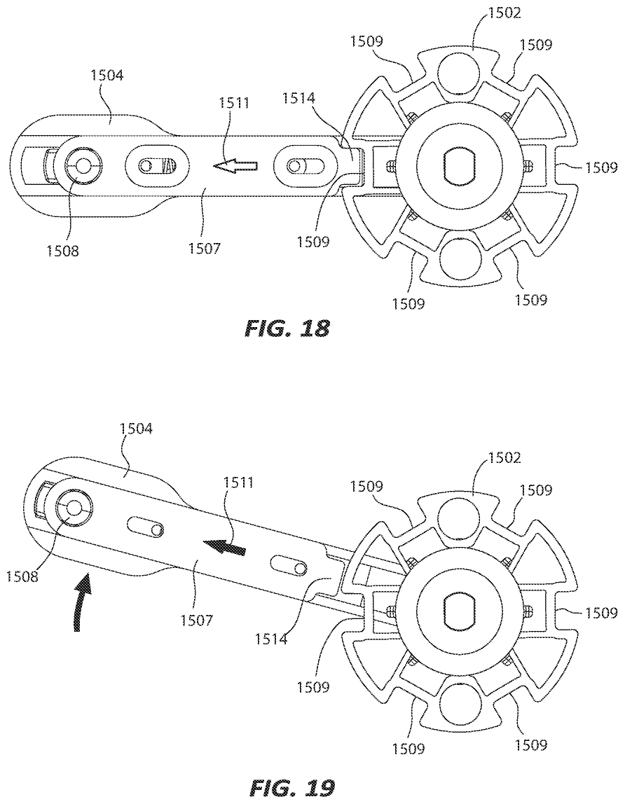

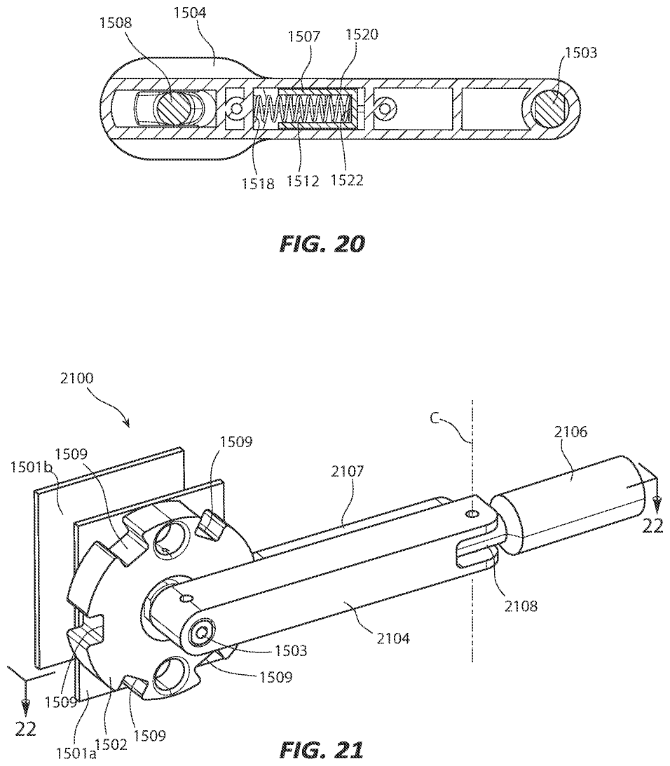

The grip member 1506 can have an end portion 1508 slidably coupled with a pin member 1507. The pin member 1507 can be coupled with the crank arm 1504 but enabled to slide parallel to the longitudinal axis of the crank arm 1504 within a range of motion (as shown by slot-and-pin features 1516 in FIGS. 18-19). The pin member 1507 has a tip 1514 that engages the plate 1502 and can be seated in one of the openings 1509 therein when in a locked configuration, as shown in FIGS. 17 and 18. Thus, when no user force is applied to the grip member 1506, the pin member 1507 can lock the rotation of the crank arm 1504 relative to the plate 1502. A biasing member or spring 1512, as shown in FIGS. 17 and 20, can bias the pin member 1507 toward the opening 1509 to prevent inadvertent withdrawal of the pin member 1507 and unlocking of the crank arm 1504 and lateral driveshaft 1503. The spring 1512 is shown in FIG. 20 applying a longitudinally-directed biasing force to the crank arm 1504 at a radially outer engagement surface 1518 and to a spring-engaging portion 1520 of the pin 1507 at a radially inner engagement surface 1522 of the spring-engaging portion 1520. The spring-engaging portion 1520 can longitudinally slide along the crank arm 1504 within a cavity defined within the crank arm 1504. The spring-engaging portion 1520 can also have a multi-sided cup-shape and can receive the spring 1512 within a cavity defined by the cup shape, as shown in FIG. 20.

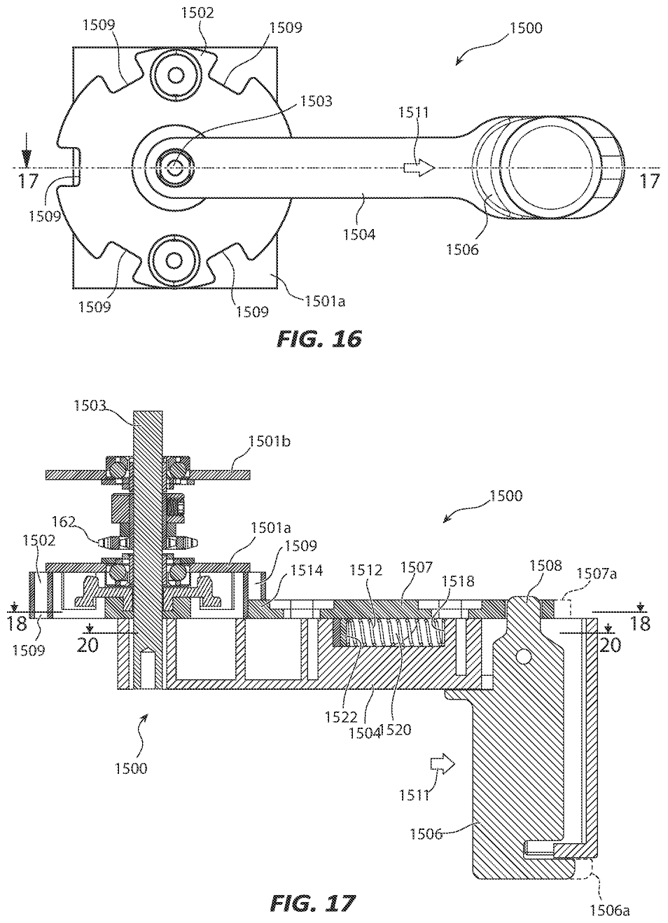

The pin member 1507 is configured to slide parallel to the longitudinal axis of the crank arm 1504 when the grip member 1506 is pulled radially away from the axis of rotation of the lateral driveshaft 1503 (i.e., in the direction of arrow 1511 in FIGS. 16-18). Thus, the grip member 1506 can be moved to position 1506a, and the pin member 1507 can be moved to position 1507a in FIG. 17. This motion can remove the pin tip 1514 from the opening 1509, as shown in FIG. 19, thereby enabling the crank arm 1504 to rotate the lateral driveshaft 1503 and gear 162 relative to the plate 1502 while the user continuously pulls the grip member 1506 away from the axis of rotation. Similar to hand control 1000, when the grip member 1506 is no longer squeezed, the pin 1507 can be biased back toward an opening 1509 to automatically lock and brake the rotation of the hand control 1500 at various angular positions around the plate 1502.

FIGS. 21-23 show aspects of a hand control 2100 that can be used with platform systems described herein. Similar components to hand control 1500 are shown with the same numbering in connection with hand control 2100. Accordingly, a plate 1502 with openings 1509, lateral driveshaft 1503 (and gear 162), rail portions 1501a, 1501b are connected to a crank arm 2104 and slidable pin member 2107 that is biased by a spring 2112 toward an opening 1509. The outer end of the crank arm 2104 can include a handle 2106 (i.e., grip member) that is rotatable relative to the crank arm 2104 about a pivot axis C that is perpendicular to a longitudinal axis of the crank arm 2104 and parallel to a plane of motion in which the crank arm 2104 is rotatable about the driveshaft 1503.

The handle 2106 can include an end portion 2108 that is movable between a first position rotated out of contact with the pin member 2107 and a second position rotated into contact with the pin member 2107 and applying a longitudinally-directed/radially outward force to the pin member 2107 (relative to the axis of rotation of the lateral driveshaft 1503). To do so, the end portion 2108 can be rotatable into an end slot 2110 or opening in the pin member 2107, wherein a side surface of the end portion 2108 pulls the pin member 2107 out of the opening 1509 by overcoming the biasing force of the spring 2112 (which can have the same configuration and features as spring 1512). Thus, rotation of the handle 2106 can unlock the hand control 2100. When the handle 2106 is released, the spring 2112 can bias and push the pin member 2107 back toward the plate 1502 and can cause the handle 2106 to rotate back to its first position that is substantially longitudinally aligned with the crank arm 2104 from its second position that is substantially perpendicular to the crank arm 2104 and parallel to the axis of rotation of the lateral driveshaft 1503. This hand control 2100 can therefore beneficially provide a user with visual confirmation that the handle 2106 is in a locked or unlocked position. Also, while the handle 2106 is in the locked position, it is more difficult to attempt to crank around the driveshaft 1503, so it intuitively communicates its locked or unlocked status to new users.

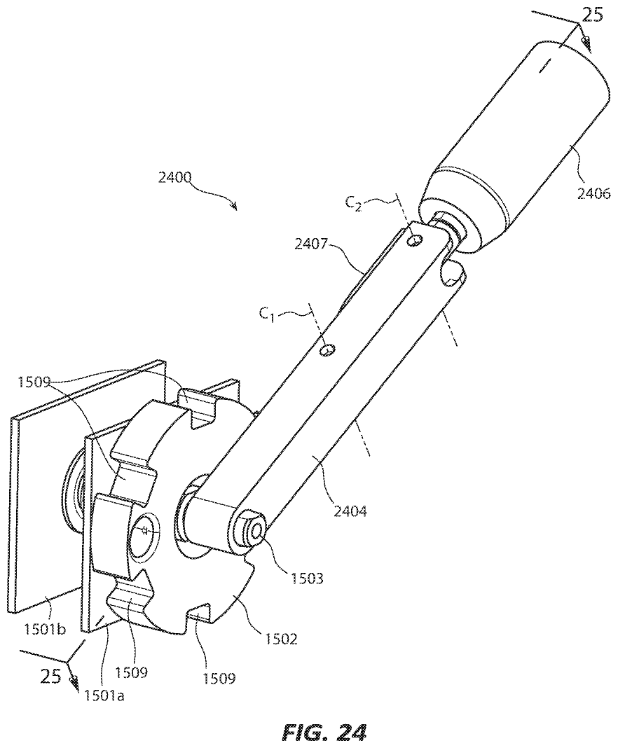

FIGS. 24-26 show aspects of yet another hand control 2400 that can be used with platform systems described herein. Similar components to hand controls 1500 and 2100 are shown with the same numbering in connection with hand control 2400. Accordingly, a plate 1502 with openings 1509, lateral driveshaft 1503 (and gear 162), rail portions 1501a, 1501b are connected to a crank arm 2404. A rotatable pin member 2407 is rotationally biased (e.g., by a torsion spring about axis C₁ or by a linear spring pulling outer end 2415 toward crank arm 2404) so that an inner pin end 2414 is in a locked position in an opening 1509 of the plate 1502. The outer end of the crank arm 2404 can include a handle 2406 (i.e., grip member) that is rotatable relative to the crank arm 2404 about a pivot axis C₂ that is perpendicular to a longitudinal axis of the crank arm 2404 and parallel to a plane of motion in which the crank arm 2404 is rotatable about the driveshaft 1503.

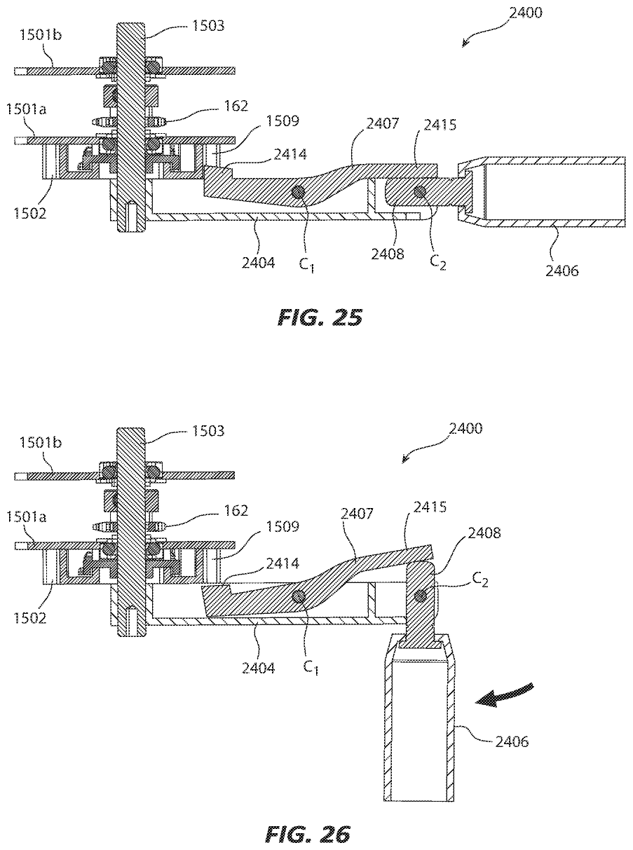

As with handle 2106, the handle 2406 can pivot between a locked position shown in FIG. 25 and an unlocked position shown in FIG. 26. In the locked position, the end portion 2408 of the handle 2406 is parallel to a longitudinal axis of the crank arm 2404, and in the unlocked position, the end portion 2408 pushes the outer end 2415 of the rotatable pin member 2407 away from the crank arm 2404, thereby rotating the pin member 2407 about its pivot axis C₁ and moving the inner pin end 2414 out of the opening 1509 of the plate 1502 in a direction parallel to the axis of rotation of the lateral driveshaft 1503. Thus, the crank arm 2404 can rotate about the longitudinal axis of the lateral driveshaft 1503 and can rotate the driveshaft 1503 relative to the plate 1502 while the pin member 2407 is unlocked. Releasing the handle 2406 can cause the handle 2406 to return to its locked, crank-arm-aligned position of FIG. 25, thereby permitting the pin end 2414 to re-lock the pin member 2407 relative to the plate 1502 when it enters an opening 1509 (potentially after some amount of rotation of the crank arm 2404 to align the pin end 2414 with an opening 1509). This embodiment can provide benefits discussed in connection with hand control 2100.

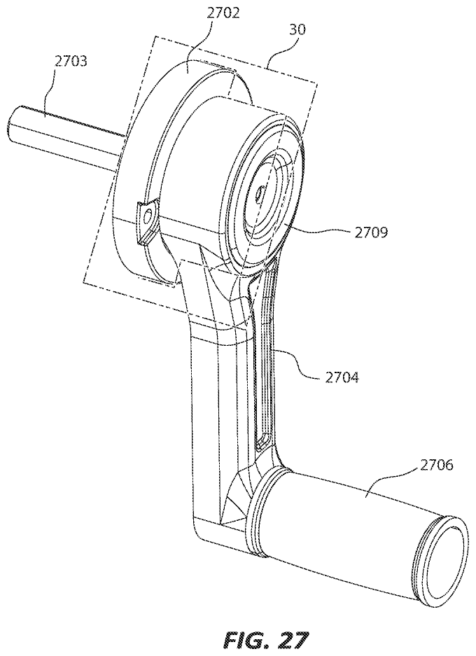

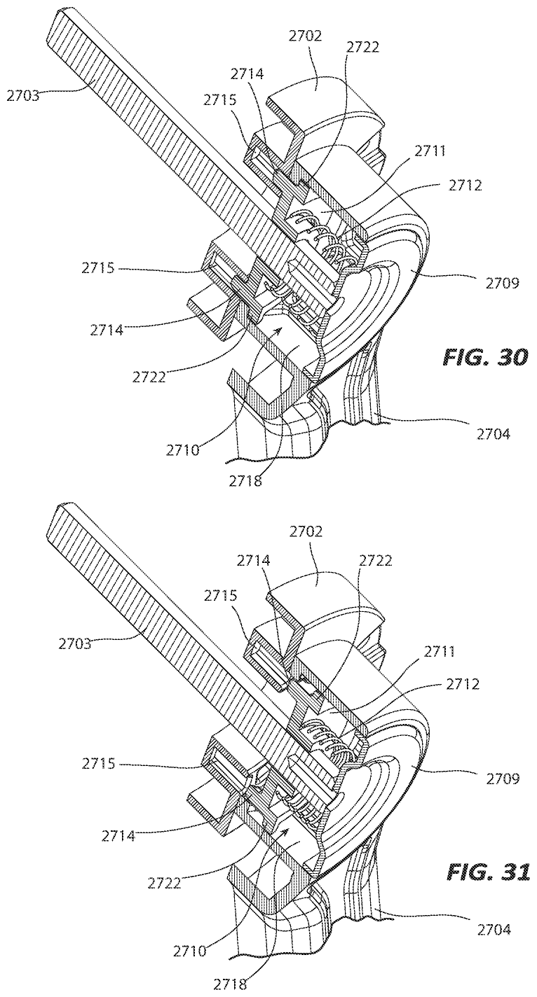

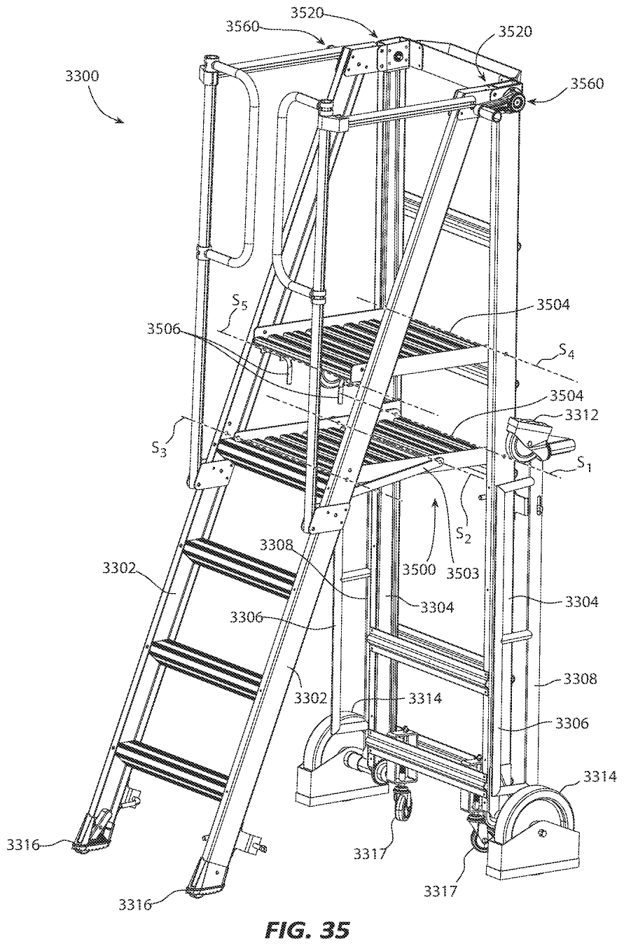

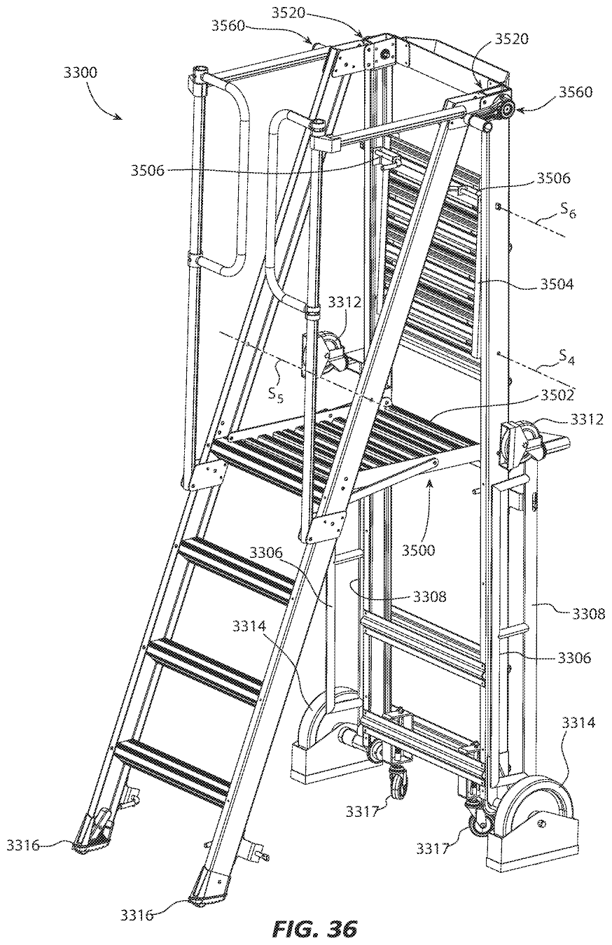

FIGS. 27-32C illustrate various aspects of a hand control 2700 with automatic braking capability that can be implemented in embodiments of platform systems and hand controls described herein. Hand controls 2700 are shown as part of the hand controls 3560 in FIGS. 35-36. The hand control 2700 can include a plate 2702 attached to a rail, hinge, or other portion of the platform system configured to be stationary relative to the handle 2706. A lateral driveshaft 2703 extends through the plate 2702 and into a cavity 2710 in the crank arm 2704, as shown in FIGS. 30-31. As with other driveshafts described herein, the lateral driveshaft 2703 can be coupled with a gear (e.g., 162) and other related drive system components. The plate 2702 and a cap 2709 can cover opposite ends of the cavity 2710. The cap 2709 can be securely held to the crank arm 2704 so that the crank arm 2704 and cap 2709, while assembled, function essentially as a single integral piece. In some embodiments, the cap 2709 can be removable (e.g., by disengaging a fastener or threads holding the cap 2709 to the crank arm 2704).

An automatic locking gear 2711 (i.e., a crown gear, crown pin, radial-longitudinal gear, or dual-pin-type gear) is positioned in the cavity 2710 and is biased away from the cap 2709 (i.e., toward the plate 2702/along the axis of rotation of the lateral driveshaft 2703) by a spring 2712 contacting an outer face of the gear 2711 and an inner face of the cap 2709. In various embodiments, the gear 2711 can be mounted to the lateral driveshaft 2703 (in which case the lateral driveshaft 2703 is movable along its longitudinal axis relative to the crank arm 2704) or can be slidable along and relative to the lateral driveshaft 2703. In either case, the gear 2711 can be movable between a locked position (FIG. 30) wherein longitudinal protrusions 2714 of the gear 2711 are in engagement with longitudinal openings 2715 (e.g., inward-projecting recesses) in the plate 2702 and an unlocked position (FIG. 31) wherein the protrusions 2714 are spaced away from and out of engagement with the openings 2715 of plate 2702. The spring 2712 can bias the gear 2711 toward the plate 2702 and can therefore be biased toward the locked position with the protrusions 2714 in the openings 2715. In the locked position, the longitudinal protrusions 2714 have outward-facing sidewalls that contact inward-facing sidewalls of the openings 2715 of the plate 2702, thereby preventing rotation of the gear 2711 relative to the plate 2702. In some cases, the sidewalls of each feature protrusion/opening 2714, 2715 can be parallel to each other and can thereby be prevented from rotating relative to each other apart without the protrusions 2714 first being at least partially withdrawn from the openings 2715 (e.g., to a position where the tapered tips of the protrusions 2714 come into contact with the inward-facing sidewalls of the openings 2715).

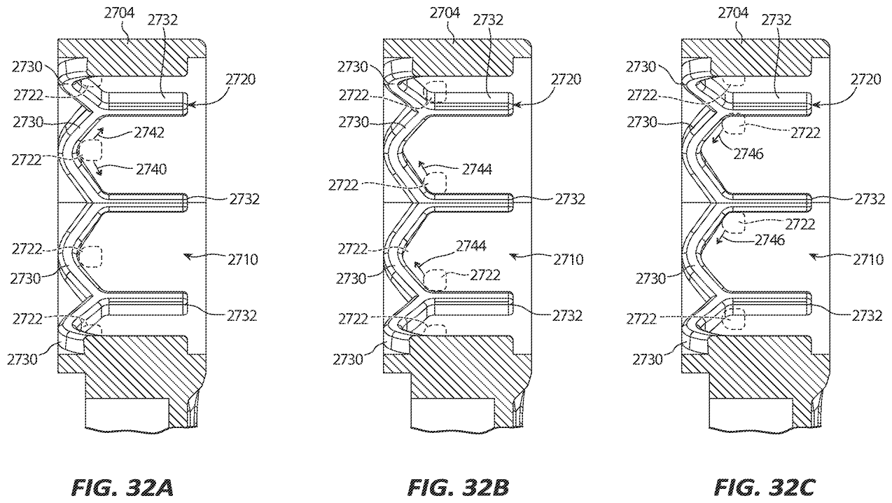

The cavity 2710 can have an inner cylindrical wall 2718 laterally/radially surrounding the locking gear 2711. The surface of the wall 2718 can include a set of angled guide features 2720 (e.g., protrusions or recesses) configured to engage with a set of radially-extending teeth 2722 of the locking gear 2711. Thus, rotation of the crank arm 2704 can cause rotation of the guide features 2720. The guide features 2720 shown in the FIGS. 27-32C protrude radially inward from the surface of wall 2718. The engagement between the guide features 2720 and the teeth 2722 can cause simultaneous rotation and longitudinal movement of the gear 2711, as shown in FIGS. 30-31 and as described in connection with FIGS. 32A-32C.

At rest, the gear 2711 is biased toward the plate 2702, and the protrusions 2714 engage the openings 2715, as described above and as shown in FIG. 30. In this state, which corresponds with the positions of teeth 2722 in FIG. 32A (which are isolated from gear 2711 and shown in broken lines for purposes of illustration), the teeth 2722 are each biased to a position as far as possible from the cap 2709 (i.e., toward the plate 2702). The teeth 2722 remain within the crank arm 2404, even if the arm 2404 is separated from the plate 2702, due to mechanical interference between the guide features 2720 and the teeth 2722. The guide features 2720 can define a V-shaped feature 2730 (i.e., a longitudinally-oriented recess) for each tooth 2722, and the V-shaped features 2730 can have walls or dividing features 2732 between each other that prevent shifting or jumping of the teeth 2722 from one corresponding V-shaped feature 2730 to another while the hand control 2700 is assembled. The V-shaped features 2730 therefore help guide the protrusions 2714 into the openings 2715 when the gear 2711 is acted upon by the spring 2712. If the gear 2711 is rotated to a position such as the positions shown in FIGS. 32B and 32C, the biasing force of the spring 2712, in connection with the sloped sides of the V-shaped features 2730, can be used guide the teeth 2722 back to the locked position of FIG. 32A by longitudinally and rotationally guiding movement of the gear 2711, as long as there is not a sufficient torque being applied to the crank arm 2704, as further described below. This movement of the gear 2711 can also guide the longitudinal protrusions 2714 to the openings 2715 to lock the crank arm 2704.

While the protrusions 2714 are in the openings 2715, the interaction between the teeth 2722 and guide features 2720 prevents rotation of the crank arm 2704 relative to the plate 2702 unless a minimum torque is applied to the crank arm 2704 that overcomes the friction (generated in part by the spring 2712) between the teeth 2722 and guide features 2720 to make the teeth 2722 slide away from the centers of the V-shaped features 2730 (i.e., as shown, for example, by arrow 2740 or 2742 in FIG. 32A) toward one of the positions of FIGS. 32B and 32C. Thus, if a torque less than the minimum torque is applied, the crank arm 2704 will not rotate due to friction inhibiting rotation of the gear 2711 and accordingly also inhibiting withdrawal of the protrusions 2714 from the openings 2715. Preferably, this minimum torque can be sufficiently large enough to limit or prevent unwanted drive motion of the platform system by the hand control 2700, but the minimum torque can also be sufficiently small so that it can be applied by an average human user when movement of the platform system is wanted. If a torque is applied in excess of the minimum torque, the crank arm 2704 will rotate as the protrusions 2714 withdraw from the openings 2715 and thereby unlock the gear 2711 and crank arm 2704 from the plate 2702.

As a user continues to apply a torque exceeding the minimum torque, the teeth 2722 will remain in the unlocked position (i.e., in one of the conditions shown in FIG. 32B or 32C), so the crank arm 2704 can be continuously rotated to provide continuous drive of the lateral driveshaft 2703, upper gear, etc. Upon reaching a torque threshold, the teeth 2722 can come into engagement with the dividing features 2732, thereby limiting the maximum amount of angular deflection/rotation of the gear 2711 relative to the crank arm 2704. Engagement with the dividing features 2732 can cause the gear 2711 to continue to move with the crank arm 2704, thereby preventing the gear 2711 from moving from one V-shaped feature 2730 to another adjacent V-shaped feature 2730, which could cause the protrusions 2714 to move back toward the openings 2715 prematurely (i.e., while the user is still cranking the handle 2706).

When torque applied to the crank arm 2704 falls below the minimum threshold level, the gear 2711 can be biased back to the locked position by the spring 2712 (e.g., along the directions of arrows 2744 or 2746). Accordingly, the user can simply stop moving the crank arm 2704 (e.g., via the handle 2706) to lock the hand control 2700 and can simply rotate the crank arm 2704 to unlock the hand control 2700. Like other hand controls described herein (e.g., 1000, 1300, 1500, 2100, and 2400), the hand control 2700 can be operated in both forward and reverse directions (i.e., clockwise and counterclockwise) and can be automatically braked after moving in either direction. This configuration can therefore provide ease of use and automatic lock and unlock ability with few, if any, external moving parts. Encasing the locking mechanism within the crank arm 2704 can therefore limit or prevent damage to the locking mechanism from outside elements (e.g., dirt, spills, falling tools, collisions, etc.).

Various hand controls described herein (e.g., 1000, 1300, 1500, 2100, 2400, 2700) can be used interchangeably with various lateral driveshafts described herein. Thus, different hand controls can be used on each side of various different platform systems (e.g., 100, 3300), with different drive mechanisms (e.g., a loop 170/belt/chain/cable or longitudinal driveshaft), etc. Disclosure of a feature in connection with one embodiment should be understood as being applicable or implementable with other embodiments.

FIG. 33 shows an embodiment of a skirt support system usable with embodiments of the platform systems described herein. The platform system 3300 can include a pair of spaced apart front rails 3302 and a pair of spaced apart rear rails 3304 with a pair of upper skirt bars 3306 coupled to the pairs of rails 3302, 3304 and an optional pair of lower skirt bars 3308 coupled with the upper skirt bars 3306 and positioned below the upper skirt bars 3306. In some embodiments, the skirt bars 3306, 3308 can be implemented in platform system 100 or other platform systems described herein.

The pair of upper skirt bars 3306 can be latched to the front rails 3302 by a pair of latches 3310 that, when engaged, rigidly keep the pair of upper skirt bars 3306 coupled to the front rails 3302. Thus, due to the coupling between the bars 3306 and the rails 3302, 3304, if one of the front wheels 3312 or rear wheels 3314 rolls into a recess or off a ledge, thereby potentially allowing the system 3300 to tilt or tip, at least one of the lower skirt bars 3308 or upper skirt bars 3306 can hold the system 3300 against a support surface between the wheels 3312/3314 (i.e., the system can high-center on the bars) to limit the amount of tilting or tipping until the system 3300 can be moved back to a proper substantially horizontal support surface where it is supported again by the wheels. As used herein, a “horizontal” support surface is within about 3 degrees of level and substantially smooth.

FIGS. 33-34 also show an embodiment where the front rails 3302 have feet 3316 suspended above the ground support surface by the wheels 3312, 3314 while the skirt support system is being used. The rear ends of the upper skirt bars 3306 can be pivotally coupled to the rear rails 3304 so that when the latches 3310 are disengaged, the upper and lower skirt bars 3306, 3308 can pivot into a position substantially parallel to (or at least more parallel to) the rear rails 3304. When the bars 3306 are pivoted into a collapsed, upward-rotated position adjacent to the rear rails 3304, as shown in FIGS. 35-36, the feet 3316 can support the system without rolling, thereby stabilizing the platform system 3300 and limiting or preventing unwanted sliding movement against the ground surface because the front wheels 3312 are not in contact with the ground support surface. Instead, the front wheels 3312 are rotatably coupled to the upper bars 3306 and are moved away from the ground support surface, so the feet 3316 support the rails 3302 and frictionally resist sliding or dragging.

In some embodiments, the skirt system can also rotate the rear wheels 3314 out of engagement with the ground support surface when in the collapsed or storage position, thereby allowing the rear rails 3304 to be supported by their own bottom ends/feet or by storage position support wheels 3317 extending below their bottom ends. The user can therefore roll the collapsed platform system 3300 from place to place with the storage position support wheels 3317 engaging the ground support surface instead of with the drive system-linked rear wheels 3314 (which may be prevented from rolling due to locking features of a brake (e.g., 600) or hand control (e.g., 2700)).

FIG. 34 illustrates a side view of the base of the system 3300 including wheels 3312, 3314 having protective shrouds 3400 extending around their lower outer perimeters. In some embodiments, a shroud 3400 can be included on at least one pair of the front wheels 3312 and rear wheels 3314 of the platform system 3300. The shroud 3400 can be configured with a perimeter-defining set of side walls 3406 to deflect large objects and debris so that they do not come into contact with the wheel 3312 below the axis of rotation Z of the wheel 3312. Accordingly, large obstacles or objects can be blocked or pushed by coming into contact with the shroud 3400 instead of the wheel 3312, and the wheel 3312 is therefore less likely to cause the platform system 3300 to tilt or tip as it maneuvers through an area with obstacles or uneven surfaces. The shroud 3400 can be configured to permit low-lying or nearly flat objects (e.g., carpet fibers, floor tiles, etc.) to pass under the shroud 3400 due to a small gap 3402 or clearance between the bottom end of the shroud 3400 and the support surface or the vertical position of the lowest point 3404 on the wheel 3312. In some embodiments, the gap 3402 can span about 0.5 inches, and in some embodiments the gap 3402 can span between about 0.25 inches to about 0.75 inches. Thus, nearly flat objects, i.e. objects that would not cause the platform system 3300 to tilt or tip, can pass under the shroud 3400. As a result, the platform system 3300 can be controlled from the platforms (e.g., 131/132) to traverse areas that are generally free from obstacles, but the platform system 3300 can be limited by the shrouds 3400 from traversing an area where it might be more dangerous to travel due to obstructions causing a tipping or tilting hazard. An operator may need to clear the area before the platform system 3300 is usable again. In some embodiments, the bottom end of the feet 3316 of the front rails 3302 can also be spaced away from the ground surface by the gap 3402 so that while the skirt support system is in the deployed position shown in FIG. 34, the front wheels 3312 support the front end of the platform system 3300 rather than the feet 3316 for easier movement of the system 3300, and when the skirt support system is the collapsed or retracted state, as shown in FIG. 35, the feet 3316 can support the front rails 3302 on the ground surface, as explained below.

FIG. 34 also indicates a clearance distance 3140 between the horizontal support surface on which the wheels 3312, 3314 ride and a bottom surface of the lower bars 3308. The skirt support system can be spaced above the ground support plane so that the wheels 3312, 3314 are the primary points of contact with the ground support plane while the system 3300 is moving. However, in situations where the ground support surface includes irregularities such as bumps, dips, drop-offs, or similar abrupt changes in the ground level or slope, the ground support surface can come into contact with the bottom surface of the lower bars 3308. The platform system 3300 can therefore high-center on the ground surface and can raise at least some of the wheels 3312/3314 away from the ground surface, thereby substantially limiting the mobility of the system 3300. The skirt support system can therefore limit or prevent movement of the platform system 3300 across uneven ground or flooring so that a user on the platform system will be less likely to maneuver into situations where the platform system 3300 will tilt, tip, or otherwise move out of the control of the user.

FIGS. 35 and 36 show perspective views of the skirt support system in a stowed or collapsed configuration. To reach this configuration, the pair of latches 3310 can be released, and the bars 3306, 3308 can be pivoted upward. In some embodiments, the latches 3310 can be used to retain the bars 3306, 3308 to the rear rails 3304 at a position above the rear wheels 3314 so that they are held in place at the rear rails 3304 until the user selects to re-deploy them back to the position of FIG. 33. In this state, feet 3316 can support the front rails 3302 and can brake or limit movement of the platform system 3300 via contact with the ground support surface so that the system 3300 is not drivable (or at least the user can tell by the friction resistance that the platform system 3300 is more difficult to drive) while the skirt support system is not coupled with the front rails 3302. Thus, the system 3300 can be less capable of movement to a position where it might tilt or tip while the skirt support system is not being used, particularly when a user's weight is on the platform(s) and is therefore pressing down on the front feet 3316. In some embodiments, in the collapsed configuration, the rear wheels 3314 can be pivoted up and away from a support surface under the storage position support wheels 3317 so that the drive system cannot move the platform system 3300.

FIG. 35 is a perspective view of the platform system 3300 including a reconfigurable platform assembly 3500 with a first platform 3502 and a second platform 3504. The first platform 3502 is positioned vertically lower in the system 3300 than the second platform 3504. In other words, first platform 3502 is closer to the base or wheels 3314 than to the top hinge 3520 or hand controls 3560 as compared to the second platform 3504. The first platform 3502 can therefore be referred to as a lower or base platform, and the second platform 3504 can be referred to as a higher or upper platform. The two platforms 3502, 3504 form a set of platform tiers for the platform assembly 3500, and a user can operate the platform system 3300 at the platform assembly 3500 to choose different height levels/vertical levels of platform support while standing at an elevated position on the platform system 3300.

The first platform 3502 is pivotally coupled to and extends between the rear rails 3304. The first platform 3502 is also pivotally coupled to a pair of linkage arms 3503 on each side (only one of which is visible in FIG. 35), and those linkage arms 3503 are pivotally coupled to the pair of front rails 3302. Thus, the first platform 3502 is pivotable relative to the rear rails 3304 about a lower rear axis of rotation S₁ and is pivotable relative to the linkage arms 3503 about a central axis of rotation S₂. The linkage arms 3503 are pivotable relative to the front rails 3302 about a front axis of rotation S₃. Accordingly, when the platform system 3300 transitions from an open or standing position (shown in FIG. 35) to a collapsed position (with rails 3302, 3304 approximated to each other, similar to FIG. 2), the first platform 3502 can pivot about the lower rear axis of rotation S₁ to a more vertically oriented position, with the central axis of rotation S₂ positioned further above the lower rear axis of rotation S₁ and nearer to the rear rails 3304. Simultaneously, the linkage arms 3503 can rotate in the opposite direction by pivoting about front axis of rotation S3 at the front pair of rails 3302 and with the central axis of rotation S₂ moving above the front axis of rotation S₃ and nearer to the front rails 3302. As a result, the first platform 3502 can be moved to a collapsed and substantially vertical position as the system 3300 is closed to its collapsed position.

The second platform 3504 is pivotally coupled to and extends between the rear rails 3304, wherein the second platform 3504 is pivotally rotatable relative to the rear rails 3304 about an upper rear axis of rotation S₄. The second platform 3504 is selectively coupled with the front pair of rails 3302 by a pair of user controlled locks, pins, or releasable latches 3506 through a front attachment axis S₅. The latches 3506 can be retained in apertures or recesses in the front rails 3302. Alternatively, the rails 3302 can bear the latches 3506, and the second platform 3504 can include openings or recesses for receiving the latches 3506. Thus, in the deployed position/support position shown in FIG. 35, the second platform 3504 is secured to the front rails 3302 and is supported by the front rails 3302 and latches 3506 so that a user can support their weight on the second platform 3504 and use the platform system 3300 from the upper level defined by the second platform 3504.

FIG. 36 shows the platform system 3300 with the platform assembly 3500 in a second configuration. The first platform 3502 is in the same position as shown in FIG. 35, but the second platform 3504 is pivoted into a stowed position/collapsed position, wherein the second platform 3504 is rotated about upper rear axis of rotation S₄ to a position in which the latches 3506 retain the second platform 3504 to the rear rails 3304 along a rear attachment axis S₆. A set of openings or recesses in the rear rails 3304 can receive the latches 3506 to create a user-controllable lock that holds the second platform 3504 in the upward-rotated/collapsed position. Alternatively, a second set of latches can be positioned on the rear rails 3304 and those latches can retain the second platform 3504 (e.g., by insertion into recesses or openings in the second platform 3504).

While the second platform 3504 is in the rear/collapsed position, a user is capable of standing on and moving across the entire top surface of the lower first platform 3502 without interference from the second platform 3504. Thus, the user can be supported at a lower vertical height and across a lower vertical plane in the platform assembly 3500 as compared to the second-platform-deployed configuration of FIG. 35. The different heights of each configuration (FIGS. 35 and 36) can improve comfort for users having different heights or for applications where a user needs to reach higher or lower work areas (e.g., on walls, windows, or ceilings of different heights) or frequently needs to switch between different levels of work areas. The user can quickly convert the system 3300 from one platform configuration to another by adjusting the second platform 3504 as needed without completely removing the second platform 3504, thereby reducing the chance that it is misplaced and increasing the chance that it is where the user needs it when an appropriate time comes.

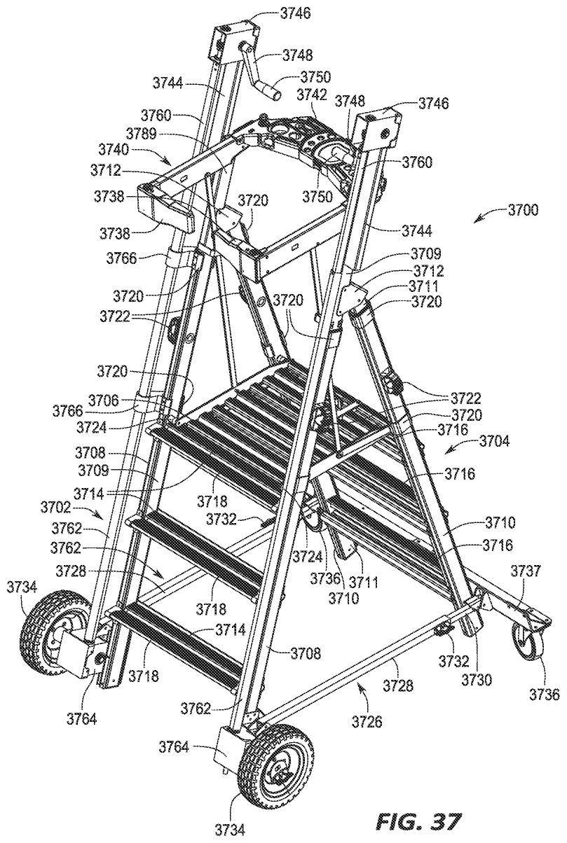

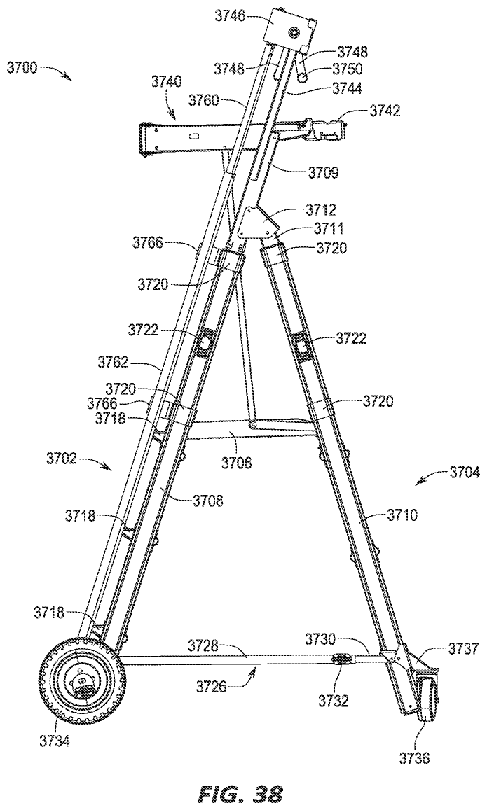

FIG. 37 shows a platform system 3700 displaying features and elements that may also be implemented as part of other embodiments shown and described herein. The system 3700 may include a first assembly 3702 pivotally joined to a second assembly 3704 and configured to support an elevated platform 3706 extending between the first and second assemblies and foldable with the assemblies. The first assembly 3702 may include a first pair of spaced apart outer rails 3708 and a first pair of spaced apart inner rails 3709, and the second assembly may include a second pair of spaced apart outer rails 3710 and a second pair of spaced apart inner rails 3711. The first and second pairs of inner rails 3709, 3711 may be directly pivotally coupled to each other at a pair of pivot brackets 3712 or hinges. See FIG. 38.

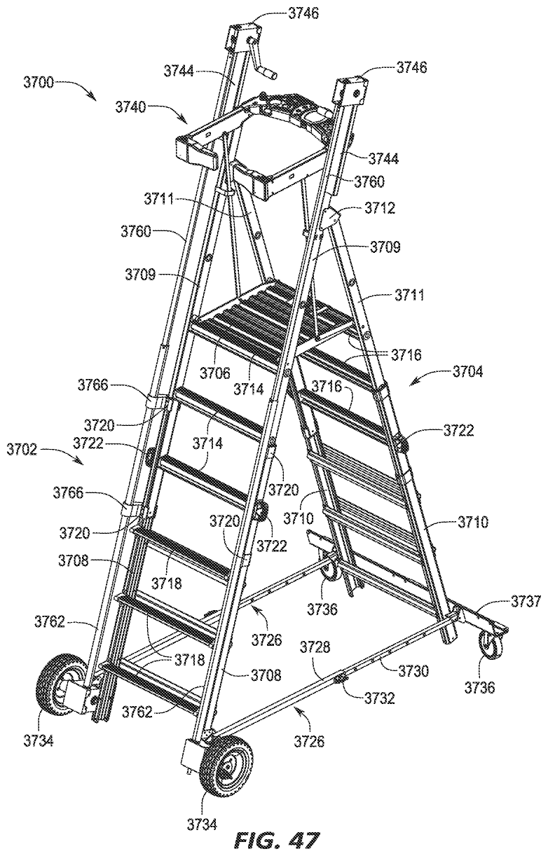

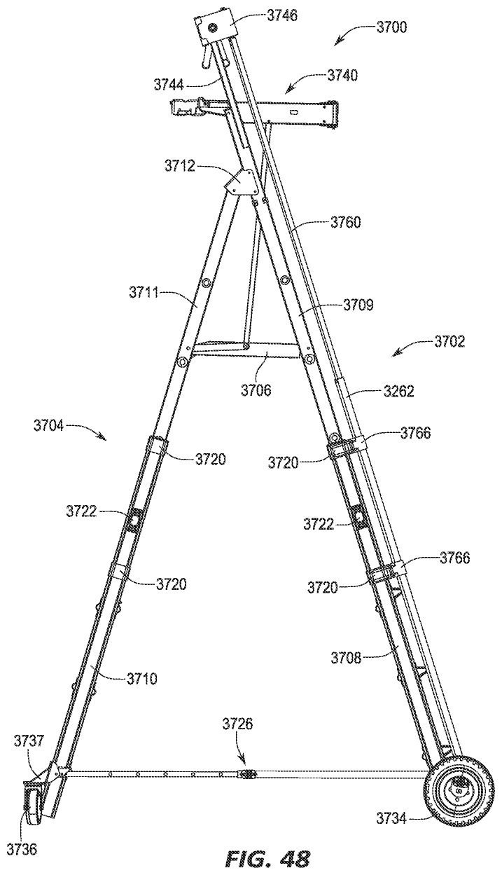

In each of the first and second assemblies 3702, 3704, the inner and outer rails may be slidably coupled to each other, such as by brackets 3720, such as, for example, a set of C-shaped brackets. The rails may be slidably coupled with the inner rails being at least partially surrounded by or nested within the outer rails and within the brackets 3720. Thus, the combined overall length of a set of inner and outer rails in the first assembly 3702 (or the second assembly 3704) may be adjustable by sliding the inner rails within the outer rails and thereby extending the height of the assembly, as shown, for example, in FIGS. 47-48. In some embodiments, each pairing of outer and inner rails (e.g., 3708 and 3709) may include at least two brackets 3720. Together, the at least two brackets 3720 may keep the outer and inner rails (e.g., 3708, 3709) longitudinally aligned and coaxial by providing two points of alignment and bracing for the outer rails relative to the inner rails. The brackets 3720 may comprise a more rigid construction (e.g., a more rigid material composition, such as metal as compared to plastic or composite) as compared to the outer rails (e.g., 3708 or 3710) to more strongly reinforce the areas of connection between the inner and outer rails where the brackets 3720 are located.

The shape of the brackets 3720 (e.g., the C-shaped cross-section) may partially wrap around the inner rail (e.g., 3709) and thereby prevent the inner rail from being laterally inwardly pulled away from the outer rail (e.g., 3708). In some embodiments, the brackets 3720 do not form a complete loop around the inner rail and instead have a gap or space on the laterally inward side of the bracket 3720, as shown in FIG. 37. The gap or space may permit the inner rungs (e.g., 3714 or 3716) to slide through and past the bracket 3720 as the inner rails longitudinally slide relative to the outer rails. Accordingly, the brackets 3720 may permit longitudinal length adjustment of the first and second assemblies 3702, 3704 without the inner rungs coming into mechanical interference with the brackets 3720 or outer rails. See also FIGS. 47-48.

Additionally, a gap or space between the outer rails 3708 may be formed between the brackets 3720 (e.g., in the gap spanned by an inner rung 3714). In other words, no additional braces or spanning links may extend between the outer rails 3708 aside from the outer rungs 3718. This may be the case across the entire length of the outer rails 3708 or at least adjacent to the platform 3706 and the space into which the platform is movable as the system 3700 folds into a collapsed configuration at the pivot brackets 3712 and at platform pivot connections 3724. Thus, the platform 3706 may fold unhindered by braces or other cross-members extending between the first assembly as the platform 3706 pivots (e.g., at pivot connections 3724) between the inner rails 3709 and the outer rails 3708.

A set of locking mechanisms 3722 may be implemented, with one locking mechanism 3722 per inner-outer rail pair (e.g., one for each inner rail 3711 and outer rail 3710 or for each inner rail 3709 and outer rail 3708, as shown in at least FIG. 37). The locking mechanism 3722 may be operable to maintain the respective longitudinal position of an inner rail (e.g., 3709 or 3711) relative to an outer rail (e.g., 3708 or 3710) so that the rungs 3714, 3718 remain in their positions relative to each other while a user climbs to the platform 3706. The locking mechanism 3722 may be operable between a locked state and a released state, wherein, when in the released state, the inner rail may slide within the outer rail to an elongated or retracted position at which the locking mechanism 3722 may return to the locked state. In some embodiments, the locking mechanism 3722 may comprise features and components of locking mechanism 3778 and may extend a pin into an opening in an inner rail to lock or unlock the movement of the inner rail relative to the outer rail.

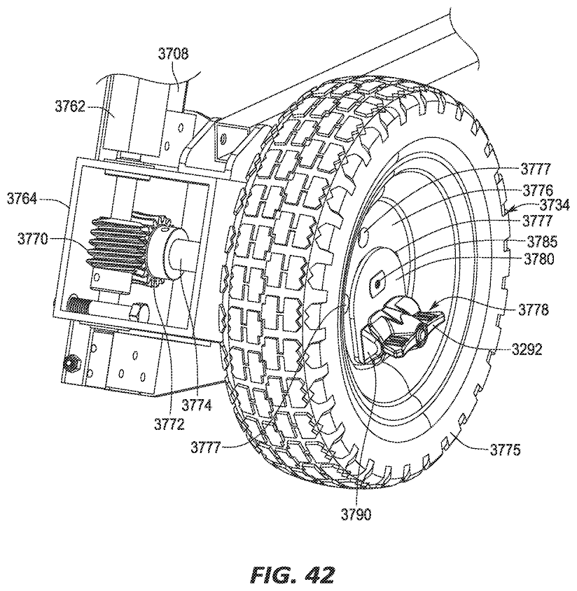

The locking mechanism 3722 may transition from the released state to the locked state automatically, e.g., in response to a biasing spring or similar feature in the locking mechanism 3722, or manually, e.g., in response to a user transitioning the locking mechanism 3722 by hand. The mechanism 3722 may be configured to manually be transitioned from the locked state to the released state, such as by a user twisting or pulling on a handle portion of the locking mechanism 3722 and withdrawing a locking member of the locking mechanism 3722 from the inner rail and/or outer rail. In some embodiments, the locking mechanism 3722 may be implemented using the locking mechanism 3778 described in connection with FIGS. 42-44C herein. In some embodiments, other locking mechanisms may be used in place of those shown in the figures, such as, for example, locking mechanisms described in connection with U.S. Pat. Nos. 8,186,481; 9,163,455; 9,784,033; 10,767,416; and 10,487,576 and U.S. patent application Ser. Nos. 17/014,271 and 17/402,309 and their related parent and child patents and applications, which are all hereby incorporated by reference in their entireties. Accordingly, the overall height of the system 3700, and the width of its base, as measured between the bottom ends of the outer rails 3708 and 3710, may be adjustable to accommodate various elevations for the platform 3706 relative to a support surface of the system 3700 as a whole.

A first set of inner rungs 3714 may be directly coupled to and extend between the first pair of inner rails 3709, and a second set of inner rungs 3716 may be directly coupled to and extend between the second pair of inner rails 3711. A set of outer rungs 3718 may be directly coupled to and extend between the first pair of outer rails 3708. As shown in FIG. 37, one of the inner rungs 3714 and one of the outer rungs 3718 may be positioned relative to each other in a pairing to form a single step, wherein the elevation of the respective top surfaces of one inner rung and one outer rung may be the same. Thus, while the system 3700 has the inner and outer rails of at least the first assembly 3702 in a longitudinally retracted state, the user may climb the assembly 3702 while being supported by an inner rung and an outer rung at one or more positions along the rails. While the system 3700 has the rails in a longitudinally extended state, such as shown in FIGS. 47-48, one or more of the individual inner and/or outer rungs may each be used as a separate step.

In some embodiments, an upper most inner rung 3714 of the first assembly 3701 or an upper most rung 3716 of the second assembly 3704 may be positioned at substantially the same elevation as a top surface of the platform 3706 or at an elevation slightly below the top surface of the platform 3706 when the system 3700 is in an upright, standing configuration. In this manner, the rung 3718 and/or 3716 may at least partially support the platform 3706 and/or may extend the usable top surface of the platform 3706 for supporting a user while he or she stands on the platform 3706 and/or upper most rungs 3718, 3716. Furthermore, in some embodiments, an upper most outer rung (e.g., 3718) may also be positioned at the elevation of the platform 3706, thereby even further extending the working and standing surface for the user.

The first assembly 3702 and second assembly 3704 may be pivotable relative to each other at pivot brackets 3712, thereby allowing the system 3700 to transition from the open, “A-frame,” or freestanding configuration of FIG. 37 to a collapsed state similar to that shown in FIG. 2, wherein the rails of the assemblies 3702, 3704 are approximated at their top and bottom ends and are substantially parallel to each other. The platform 3706 may be directly pivotally coupled to the inner rails 3709 of the first assembly 3702 and may rotate about those pivot connections 3724 from the horizontal, open position shown in FIG. 37 to a collapsed, tilted position between the pairs of inner rails 3709 and/or 3711, similar to the position shown for platform 131 in FIG. 2. When in the freestanding configuration, the rails of the first assembly 3702 may extend at about the same angle relative to a vertical direction as the rails of the second assembly 3704, as shown in FIG. 38. Thus, while the user is positioned on the platform 3706, he or she may feel more stable and comfortable that the system 3700 will not tip or lean forward or backward.

A spreader or spacer bar system 3726 may be implemented extending between rails on one or both lateral sides of the first assembly 3702 and the second assembly 3704. The spacer bar system 3726 may be used to lock the system 3700 in an open/freestanding configuration at various height configurations of the first and second assemblies 3702, 3704. For instance, the spacer bar system 3726 may include a first tubular bar 3728 and a second tubular bar 3730 that are configured to telescopically slide relative to each other to adjust their overall combined length between the assemblies 3702, 3704. FIGS. 47-48 show the bars in an extended configuration relative to FIGS. 37-38. The tubular bars 3728, 3730 may have a rectangular, square, or other polygonal cross-section, and at least one of the bars 3728, 3730 may be telescopically received within a central opening of the other bar. In some embodiments, the inner perimeter of a bar may have a different shape profile (e.g., square) as compared to its outer perimeter shape profile (e.g., round).

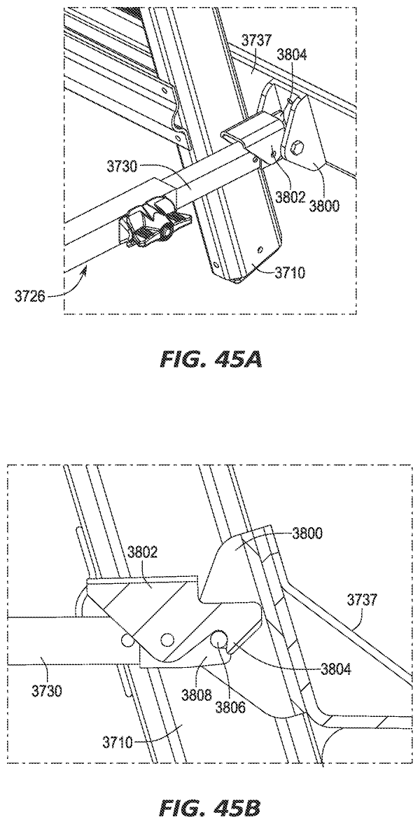

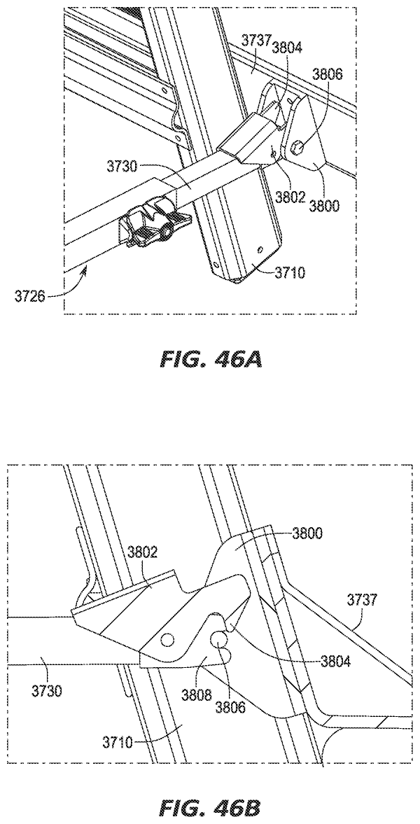

A locking mechanism 3732, similar to locking mechanisms 3722, may be implemented on the spacer bar system 3726 to selectively lock or unlock the telescoping movement of the bars 3728, 3730 relative to each other. Thus, with the locking mechanism 3732 in an unlocked or released state, the second tubular bar 3730 may slide within the first tubular bar 3728 to extend the length of the spacer bar system 3726 as the outer rails of the first and second assemblies 3702, 3704 are adjusted relative to the inner rails of the first and second assemblies 3702, 3704 to increase the height of the system 3700 and to thereby increase the distance between the bottom ends of the outer rails of each of the assemblies 3702, 3704. An end of the first tubular bar 3728 may be pivotally coupled to a bottom end of the first assembly 3702 (e.g., to an outer rail 3708 or gear box 3764), and an end of the second tubular bar 3730 may be releasably coupled to a bottom end of the second assembly 3704 (e.g., to outer rail 3710 or a wheel support bar 3737). In this manner, the second tubular bar 3730 may be lifted away and separated from the second assembly 3704 while the length of the spacer bar system 3726 is adjusted or while the spacer bar system 3726 is not being used. A coupling apparatus for securing the second tubular bar 3730 to the second assembly 3704 is described in connection with FIGS. 45A-46B.

The spacer bar system 3726, when coupled to the first and second assemblies 3702, 3704, may reinforce and rigidize the platform system 3700 to minimize wobble or relative movement of the bottom of the first assembly 3702 relative to the bottom of the second assembly 3704. In some embodiments, the spacer bar system 3726 may have strength sufficient to support the platform system 3700 if it should move to an unstable position or an uneven location. For example, the spacer bar system 3726 may support the system 3700 if a first pair of wheels 3734 of the first assembly 3702 moves to a different elevation than a second pair of wheels 3736 of the second assembly 3704. The spacer bar system 3726 may catch the platform system 3700 or reduce its maximum tilt angle if a wheel or a pair of wheels 3734, 3736 moves off a ledge (e.g., off of a stair step or curb, into a pothole, or over a similar drop-off).

The platform system 3700 may be operated as a mobile platform system, similar to other mobile platform systems described herein, wherein a user may ascend to the platform 3706, enter the platform 3706 through a pair of gates 3738, and, while standing on the platform 3706 within a cage system 3740, drive the platform system 3700 across a support surface. The gates 3738 may have a one-way pivoting construction, wherein the innermost tips of the gates 3738 may rotate forward as a user enters the cage system 3740 and then may be biased back to the position shown in FIG. 37 (e.g., via a torsion spring) after the user enters the cage system 3740. The gates 3738 may then be prevented or limited in rearward rotation (i.e., rotation away from shelf 3742 of the cage system 3740) to help keep a user within the cage system 3740 until he or she manually rotates the gates 3738 forward (toward shelf 3742) to exit the cage system 3740. Various features and embodiments of the cage system 3740 may include components and elements described in U.S. patent application Ser. No. 17/525,121, filed 12 Nov. 2021, which is hereby incorporated by reference in its entirety.

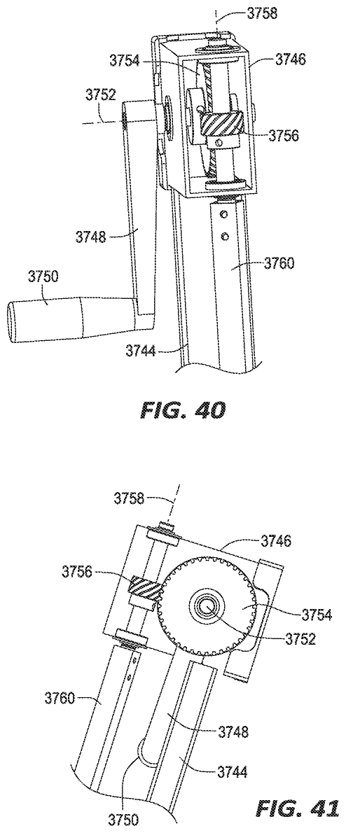

The cage system 3740 may be at least partially mounted, on its lateral sides, to inner rails 3709 of the first assembly 3702 and/or to one or more rail extension members 3744 that extend the longitudinal lengths of the inner rails 3709 upward relative to the platform 3706. The pair of rail extension members 3744 (or, in some embodiments, the inner rails 3709) may have a pair of upper gear boxes 3746 attached to upper ends thereof. A pair of hand cranks 3748 (or turnable wheels or other graspable hand controls) may extend laterally inward (or outward) from the upper gear boxes 3746 and may be accessible to the user while he or she stands on the platform 3706. The hand cranks 3748 may include handles 3750 for rotation of the hand cranks 3748 about their axes of rotation (e.g., 3752 in FIG. 40) extending through the upper gear boxes 3746.

As shown in FIGS. 40-41, the upper gear boxes 3746 may each house a crank gear 3754 and a transmission gear 3756 that are enmeshed or engaged with each other. The crank gear 3754 may rotate about crank rotation axis 3752, and the transmission gear 3756 may rotate about transmission rotation axis 3758. Crank rotation axis 3752 may be oriented substantially perpendicular to, and forwardly offset from, the transmission rotation axis 3758. Accordingly, rotation of the hand cranks 3748 about axis 3752 may cause axial rotation of an upper transmission member 3760 extending parallel to the inner rail 3709 of the first assembly 3702 via rotation of the crank gear 3754 and the transmission gear 3756.

In some embodiments, the crank gear 3754 and the transmission gear 3756 are configured as screw gears or helical gears. The teeth of the screw gears or helical gears may beneficially minimize slop or wobble in the rotation of the hand cranks 3748, thereby providing improved stability and predictability to the operation of the platform system 3700 as a user manually drives the system 3700 across a support surface via the hand cranks 3748. In some embodiments, other types of gears may be implemented for the crank gear 3754 and transmission gear 3756, such as a worm gear system, a bevel gear system, a miter gear system, a hypoid gear system, similar gear systems, and combinations thereof.

Each upper transmission member 3760 may be rotationally coupled with a respective lower transmission member 3762 that extends into a respective lower gear box 3764 positioned near a bottom end of a respective outer rail 3708 of the first assembly 3702. See FIGS. 37, 39, and 42. The user may drive the platform system 3700 with independent forward and backward driving control on each side (e.g., respective left and right sides) via the hand cranks 3748.

The upper transmission member 3760 may have a non-circular (e.g., rectangular or square) outer surface that engages a non-circular (e.g., correspondingly rectangular or square) inner surface of the lower transmission member 3762. Alternatively, a coupling fastener (e.g., a pin or set screw) may extend through both transmission members 3760, 3762 to synchronize their axial rotations. In some embodiments, the upper transmission member 3760 may have a greater width/diameter than, and may therefore receive, the lower transmission member 3762. In some embodiments, the outer perimeter surfaces of the upper and lower transmission members 3760, 3762 may have rounded edges or may be cylindrical to accommodate gripping by a user (e.g., having a circular outer surface when viewed in cross-section), and a spline or other interface may be formed to transfer torque between the members 3760, 3762, such as, for example, at least one ridge, key, or protrusion formed on the upper transmission member 3760 and at least one corresponding groove, keyway, or recess formed on the lower transmission member 3762 that receives the ridge, key, or protrusion. In some embodiments, a segment of one of the transmission members that is received by the other transmission member has a non-circular shape, and the other transmission member has a corresponding portion with a non-circular shape to transfer torque between the members.

The upper transmission member 3760 and lower transmission member 3762 may be longitudinally movable relative to each other, whereby the overall, combined length of the upper and lower transmission members 3760, 3762 (e.g., as measured between the upper gear box 3746 and the lower gear box 3764) may be adjustable or variable. For example, the combined length of the transmission members may extend or retract to accommodate respective longitudinal extension or retraction of the inner rails 3709 relative to the outer rails 3708. Thus, as the height or longitudinal length of the first assembly 3702 changes, the combined length of the transmission members may correspondingly adjust to ensure that the transmission consistently transfers torque between the upper and lower gear boxes 3746, 3764. See also FIGS. 47-48.

The transmission members 3760, 3762 may also beneficially be formed as rigid poles, shafts, or tubular members in a manner that allows them to transfer torque with low losses due to friction, slop, slack, or blowback. In some embodiments, the transmission members 3760, 3762 are positioned on the front side of the first assembly 3702, i.e., on the opposite side of the first assembly 3702 as compared to the second pair of wheels 3736 or as compared to the second assembly 3704. Thus, the transmission members 3760, 3762 may be graspable as handle bars or handrails while a user moves to and from the platform 3706.

The transmission members 3760, 3762 may be held spaced away from the rails 3708, 3709 by one or more outward- or front-extending portions 3766 of one or more of the C-shaped brackets 3720, as shown in FIGS. 37, 38, 47, and 48. In some embodiments, the front-extending portions 3766 may encircle and surround the outer perimeter(s) of the transmission member(s) extending through them, as seen in the left side of FIG. 37. The transmission member(s) within the front-extending portions 3766 may axially rotate in place without the brackets 3720 preventing the axial rotation. In some embodiments, one or more (e.g., all) of the brackets 3720 may omit front-extending portions 3766, as shown on the right side of FIG. 37. Furthermore, in some embodiments, all of the brackets 3720 may be formed without front-extending portions 3766.

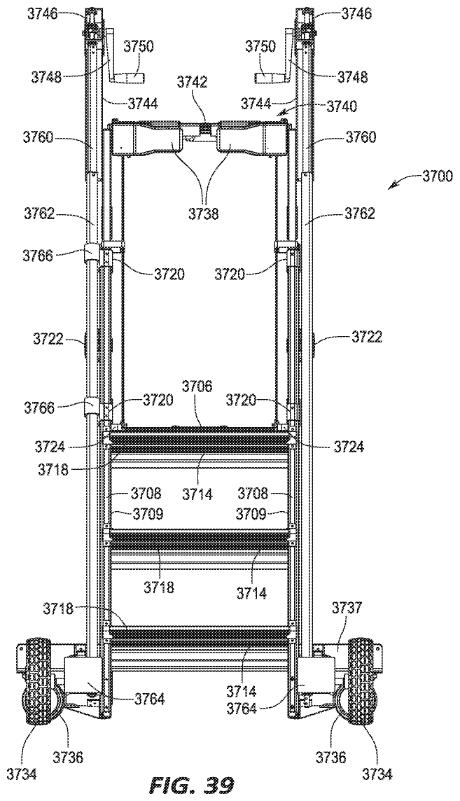

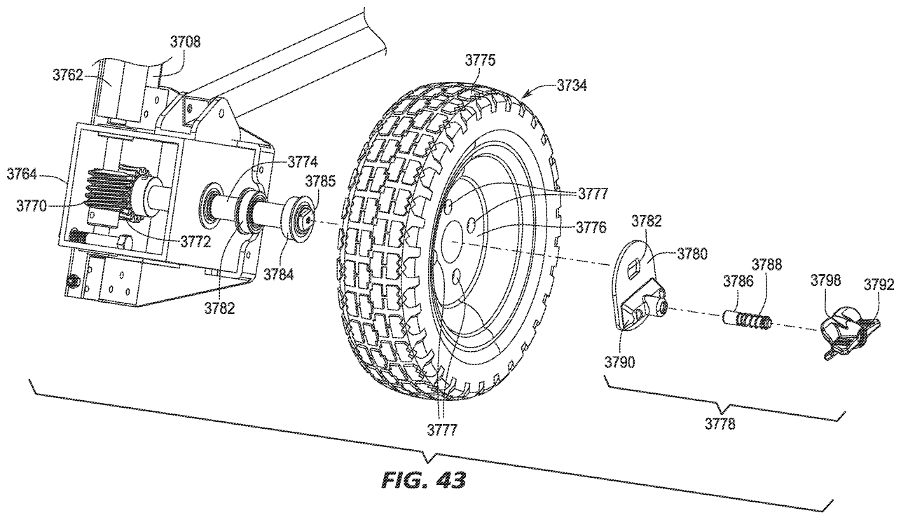

Each lower gear box 3764 may be mounted to an outer rail 3708 of the first assembly 3702 or to a member coupled to the bottom end of the outer rail 3708. See FIGS. 42-43. FIG. 43 is a partially exploded view of a lower gear box 3764 and associated wheel assembly. In FIGS. 42-43, the interior of the lower gear box 3764 is shown, but in some embodiments, as shown in FIGS. 37 and 39, the lower gear box 3764 may include a cover panel or plate that encloses and protects the interior components of the lower gear box 3764. The upper gearboxes may be similarly closed off and covered.

The lower gear box 3764 may contain a second transmission gear 3770 enmeshed with and capable of driving rotation of a wheel gear or drive gear 3772 within the lower gear box 3764. The second transmission gear 3770 may be axially rotatable by a connection to (e.g., a shaft or linkage connecting it to) the lower transmission member 3762. The drive gear 3772 may be coupled with a drive shaft 3774 or axle extending substantially horizontally out of the lower gear box 3764 and rotatable to drive rotation of at least one of the first pair of wheels 3734. Thus, rotation of the lower transmission member 3762 may drive rotation of the drive shaft 3774 via interaction between the second transmission gear 3770 and the drive gear 3772. The second transmission gear 3770 and drive gear 3772 may comprise a worm gear system, a bevel gear system, a miter gear system, a hypoid gear system, similar gear systems, and combinations thereof. The axis of rotation of the second transmission gear 3770 may be substantially perpendicular to, and laterally offset (e.g., frontally or rearwardly offset) from, the axis of rotation of the drive gear 3772 extending axially and longitudinally through the drive shaft 3774.

The second transmission gear 3770 may be substantially prevented from being driven by the drive gear 3772 due to the second transmission gear 3770 being a helical or worm gear and the drive gear 3772 being a standard, straight-toothed gear or worm wheel. Rotation of the drive gear 3772 may move the straight teeth substantially perpendicular to the teeth of the second transmission gear 3770, and the transmission gear 3770 may therefore resist rotation due to friction braking. However, rotation of the transmission gear 3770 may rotate the drive gear 3772 due to the rotation of the helical gear teeth driving rotation of the straight teeth with significantly less friction. In this manner, when the second transmission gear 3770 is a helical gear and when the drive gear 3772 has straight teeth engaging the helical tooth/teeth of the second transmission gear 3770, the wheels 3734 may have a type of automatic braking that limits rotation of the wheel 3734 via the drive shaft 3774 and drive gear 3772 unless the user operates the handles 3750 to rotate the second transmission gear 3770. In some embodiments, a locking mechanism (e.g., 3778) associated with the wheel 3734 may need to be in a locked configuration to enable this automatic braking, or else the wheel 3734 may still rotate about the drive shaft 3774 without having to move the drive gear 3772 as well due to bearings 3782, 3784, as described below. An example locking mechanism 3778 is described in further detail in connection with FIGS. 42-44C.

In some embodiments, the transmission gears 3756 and 3770 may be referred to as drivers, rotational links, or torque-transferring devices. The crank gear 3754 may be part of a handle assembly or crank assembly which also may include a hand crank 3748 and handle 3750. The drive gear 3772 may be part of a wheel assembly or roller assembly which also may include a drive shaft 3774 and one of the first pair of wheels 3734. The handle assembly and wheel assembly, with the drivers, may be collectively referred to as a drive system for the platform system 3700. Each of the handles 3750 may be rotatable to respectively drive rotation of each of the first pair of wheels 3734. Each of the driven wheels 3734 may be independently driven or rotated independent of the other wheel, including one wheel being driven in one direction (e.g., forward or clockwise) and the other wheel being driven in the opposite direction (e.g., backward or counter-clockwise).

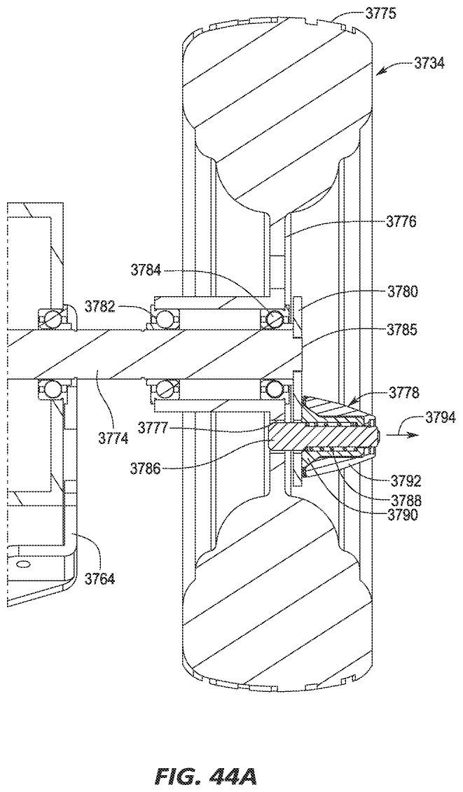

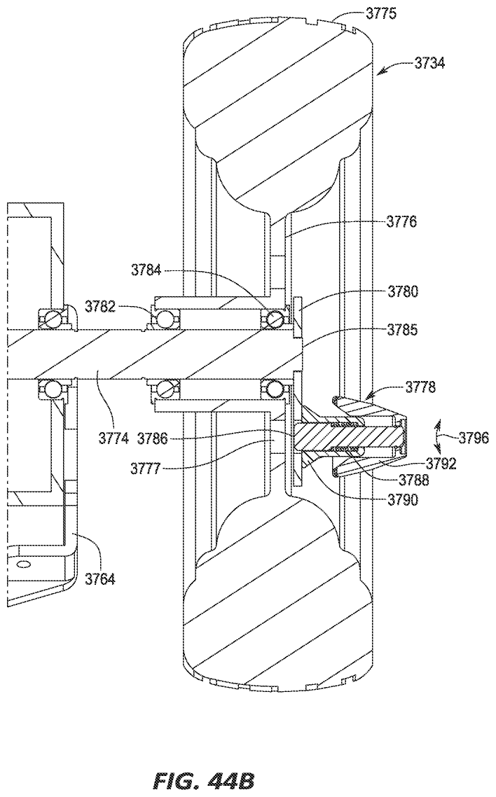

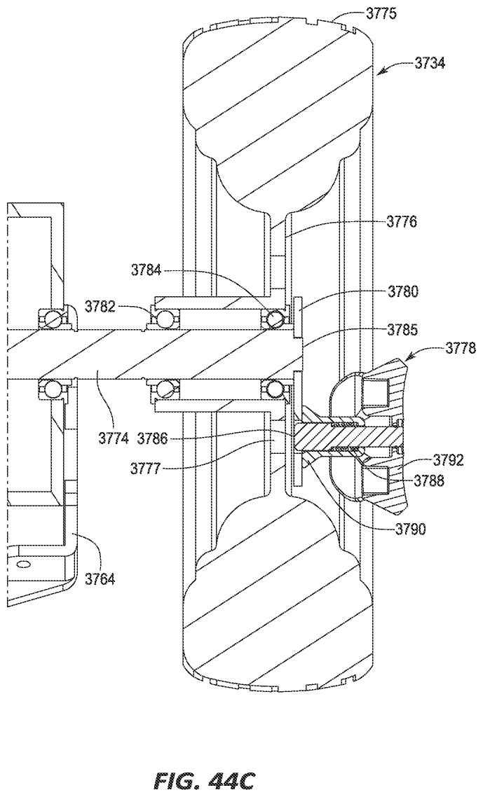

The wheel 3734 may comprise a central wheel hub 3776 or rim surrounded by a tread or tire portion 3775. The wheel 3734 may be mounted to the drive shaft 3774 via one or more bearings 3782, 3784. The bearings 3782, 3784 may allow the wheel 3734 to axially rotate about the drive shaft 3774 with low friction. The wheel 3734 may be rotatable about the axis of the drive shaft 3774 irrespective of rotation of the drive shaft 3774 while a locking mechanism 3778 of the wheel 3734 is in an unlocked state, and the wheel 3734 may be driven by the drive shaft 3774 while the locking mechanism 3778 is in a locked state, as shown in FIGS. 44A-44C. When the wheels 3734 are in an unlocked state, the platform system 3700 may be tilted and rolled on those wheels 3734, even when the first and second assemblies of the system 3700 are in their parallel, collapsed configuration.

As shown in at least FIGS. 37 and 39, the first pair of wheels 3734 and the second pair of wheels 3736 may be laterally spaced outward relative to the rails of the first and second assemblies of the platform system 3700. This broadened stance of the system 3700 may provide improved stability due to the broader base of support for the system 3700. The first pair of wheels 3734 may comprise a tire or other resilient outer material to improve grip and traction of the wheels 3734 against a support surface. The second pair of wheels 3736 may comprise a rotatable caster wheel to enable easy maneuvering and changing of direction of the system 3700 across a support surface as each wheel of the first pair of wheels 3734 is driven forward or backward. Thus, the second pair of wheels 3736 may rotate to accommodate any movement urged by the first pair of wheels 3734.

In some embodiments, the first assembly 3702 may have the first pair of wheels 3734 which are the driven wheels of the platform system 3700. In some embodiments, the second assembly 3704 may comprise the first pair of wheels 3734, and those wheels may be driven, similar to how the wheels 116 and 3314 are driven in other embodiments disclosed herein. When the driven wheels (e.g., 3734) are positioned on the first assembly 3702 (e.g., the assembly that the user uses to climb onto the platform 3706 via the rungs 3714, 3718), the system 3700 may beneficially have less wobble as the user ascends to the platform 3706 as compared to if the driven wheels 3734 are on the second assembly 3704 since the driven wheels 3734 may be automatically braked by the interaction between the transmission gear 3770 and drive gear 3772, as described in connection with gears 3770 and 3772 herein. Additionally, in embodiments where the second pair of wheels 3736 are caster wheels, they may roll and move laterally as a user steps onto a rung extending between them, but the first pair of wheels 3734, due to their fixed axis of rotation, may be prevented from laterally rolling, thereby granting stability to the user as he or she steps onto the rungs.

FIGS. 44A-44C show section views of the wheel 3734, locking mechanism 3778, and drive shaft 3774 in various states of the locking mechanism 3778. As shown in FIGS. 42-44C, the wheel hub 3776 may comprise a series of openings 3777 (e.g., through-holes, recesses, apertures, or similar spaces) that face or open toward the locking mechanism 3778. The locking mechanism 3778 may be mounted to an end of the drive shaft 3774. The locking mechanism 3778 may include a drive plate 3780 having a keyed opening 3781 configured to receive an end key 3785 of the drive shaft 3774. The fit between the keyed opening 3781 and the end key 3785 may ensure that the drive shaft 3774 has synchronized rotation with the drive plate 3780. Thus, rotation of the drive shaft 3774 causes rotation of the drive plate 3780, and, accordingly, rotation of the rest of the locking mechanism 3778, about the axis of rotation of the drive shaft 3774.

The locking mechanism 3778 may also include a locking pin 3786 axially movable between a wheel-engaging position (which is shown in FIG. 44A) and a free-wheel position (which is shown in two different ways in FIGS. 44B and 44C). While in the wheel-engaging position, the locking pin 3786 extends into (or through) at least one of the openings 3777 of the wheel hub 3776, and while in a free-wheel position, the locking pin 3786 is withdrawn from, and does not engage, any opening 3777. The locking pin 3786 may be biased toward the wheel hub 3776 by a spring or other biasing member 3788 that engages a surface of the locking pin 3786 and a surface of a bracket 3790 surrounding the locking pin 3786 and that is part of the locking mechanism 3778.

A handle 3792 may be coupled to the locking pin 3786, as shown in FIGS. 42 and 44A. Withdrawal of the handle 3792 away from the wheel hub 3776 (e.g., in the direction of arrow 3794 may withdraw the locking pin 3786 from the opening 3777 and compress the biasing member 3788, as shown in FIG. 44B. Thus, the handle 3792 may be pulled to transition the locking mechanism 3778 from the wheel-engaging position to a free-wheel position. While the handle 3792 and pin 3786 remain in the withdrawn state relative to the openings 3777, the wheel 3734 may not be driven by the drive shaft 3774, and the wheel 3734 may therefore be in a neutral state. When in the neutral state, the wheel 3734 may not respond to rotation of the handles 3750 or other drive components of the system 3700.

Furthermore, the wheel 3734 may rotate to an angle where none of the openings 3777 align with the locking pin 3786. Then, even if the handle 3792 is released and the locking pin 3786 moves back toward the wheel hub 3776, the wheel 3734 may be in a free-wheel rotatable state relative to the drive shaft 3774 until the locking pin 3786 is biased back into one of the openings 3777 due to rotation of the wheel 3734 (e.g., due to the wheel 3734 moving to an angle aligning one of the openings 3777 with the locking pin 3786).

In some embodiments, the handle 3792 may be movable to a suspended state that keeps the locking pin 3786 suspended away from the wheel hub 3776 and openings 3777 without application of an outside pulling force on the handle, as shown, for example, in FIG. 44C. The handle 3792 may be movable to that state by withdrawal of the handle 3792 (e.g., along arrow 3794) and then by axial rotation of the handle 3792 (e.g., as shown by arrow 3796 in FIG. 44B). Axial rotation of the handle 3792 by about 90 degrees can position the handle 3792 in a state where it is held in place by the bracket 3790, such as by engaging one or more small dimples 3798 on an inner end of the inward-extending flanges of the handle 3792. The biasing member 3788 may bias the handle 3792 toward the bracket 3790 to help keep it in that rotated, pin-unlocked position until user intervention moves the handle 3792 back to one of the states shown, for example, in FIG. 44A or FIG. 44B. Thus, the platform system 3700 may be transitioned to a neutral wheel state while the locking mechanism 3778 remains in a secured, unlocked state shown in FIG. 44C. Then, when the time comes for the user to drive the ladder using the handles 3750, the user may lock the pins 3786 (as shown in FIG. 44A) to re-engage the wheel 3734 to the drive shaft 3774 and, accordingly, the other intervening parts linking back to the handles 3750.

As shown in FIGS. 37-39, the second pair of wheels 3736 may be directly coupled with a wheel support bar 3737 that allows the second pair of wheels 3736 to be positioned laterally spaced away to the sides of the second assembly 3704. The support bar 3737 may be directly coupled to one or both of the outer rails 3710 of the second assembly 3704 and may therefore extend and retract with the bottom ends of the outer rails 3710. The support bar 3737 may also beneficially extend between the bottom ends of the outer rails 3710 in a manner that will allow the system 3700 to catch itself upon the support bar 3737 if one of the wheels 3736 moves to a different elevation than the opposite wheel 3736 and the system 3700 tilts. Additionally, the support bar 3737 may act as a barrier that prevents objects in the path of the platform system 3700 from passing under the second assembly 3704 due to colliding with the objects before they can pass under the second assembly 3704. This can help limit any propensity of the system 3700 from running over large objects with the wheels 3734, 3736 and thereby potentially becoming unstable.

As shown in FIGS. 45A-46B, the support bar 3737 may be removably coupled to second tubular bar 3730 via a bracket 3800 coupled with the support bar 3737 and a clip 3802 coupled with the second tubular bar 3730. The configuration of FIGS. 45A-45B may be referred to as a locked or connected configuration, and the configuration of FIGS. 46A-46B may be referred to as an unlocked or released configuration. While in the locked configuration, the clip 3802 may have a hooked end portion 3804 at least partially surrounding a pin 3806 extending through the bracket 3800. The pin 3806 may also be surrounded on three sides (e.g., top, bottom, and front sides) by a u- or c-shaped end member 3808 of the second tubular bar 3730. Accordingly, the end member 3808 may prevent movement of the pin 3806 vertically and toward the second tubular bar 3730 or the bottom of the first assembly 3702, and the hooked end portion 3804 may prevent movement of the pin 3806 away from the bottom of the first assembly 3702 or away from the second tubular bar 3730. The hooked end portion 3804 may be rotatable about a horizontal axis extending through the second tubular bar 3730, to transition to the unlocked or released configuration. In that state, the second tubular bar 3730 may be separated from (e.g., pulled away from) the pin 3806, thereby releasing the second tubular bar 3730 from the second assembly 3704 and permitting hinge movement of the rails of the second assembly 3704 relative to the first assembly 3702. Transition to the unlocked or released configuration may be required to permit extension of the lengths of the rails of the first assembly 3702 or second assembly 3704 since the length of the spacer bar system 3726 may need to change in order to accommodate the change in distance between the bottom ends of the rails. In some embodiments, the distance between the bottom ends of the rails (e.g., 3708 and 3710) may be required to increase in order for the platform 3706 to unfold to its flat position (shown, for example, in FIG. 47).

In some embodiments, the spacer bar system 3726 on each side may be adjusted in length without transitioning the hooked end portion 3804 to the unlocked or released configuration. For example, the locking mechanisms 3732 for each spacer bar system 3726 may be transitioned to a perpetually unlocked state (e.g., with a spring loaded pin similar to pin 3786 removed from one or more openings (which are shown, for example, in FIGS. 47-48) in one or both of the tubular bars 3728, 3730). While in the perpetually unlocked state, the user may increase the distance between the bottom ends of the rails 3708, 3710 without the locking mechanisms 3732 preventing lengthening or shortening of the spacer bar system 3726. Then, when the rails 3708, 3710 are in a final desired position, the user may re-lock the locking mechanisms 3732 (e.g., allowing pins to re-enter the one or more openings of the tubular bars 3728, 3730), thereby also locking the lengths of the spacer bar systems 3726 between the bottom ends of the rails 3708, 3710.

FIGS. 47-48 show views of the platform system 3700 in an expanded and increased height configuration relative to the configuration shown in FIGS. 37-39. As explained above, the outer rails 3708 may be locked to the inner rails 3709 by a locking mechanism 3722 on each side of the first assembly 3702. Similarly, outer rails 3710 may be locked to inner rails 3711 by locking mechanisms 3722 on each side of the second assembly 3704. Releasing the locking mechanisms 3722 may allow sliding extension or retraction of the overall distance between the top ends of the inner rails and the bottom ends of the respective outer rails. The configuration shown in FIGS. 47-48 show both first and second assemblies 3702, 3704 extended in length. The spacer bar systems 3726 are also extended to accommodate the distance between the bottom ends of the assemblies 3702, 3704 so that the angle at the pivot brackets 3712 and the distance between the inner rails 3709 and 3711 where the platform 3706 extends horizontally remains the same as in the configuration of FIGS. 37-39.

FIGS. 47-48 also show how the lengthening of the rails 3708, 3708 can be accompanied by lengthening of the upper and lower transmission members 3760, 3762. For example, the upper transmission member 3760 may slide within the lower transmission member 3762 without moving far enough to be removed from the end of the lower transmission member 3762, and the transmission members may remain engaged with each other for transferring torque and rotation about their common longitudinal axis.

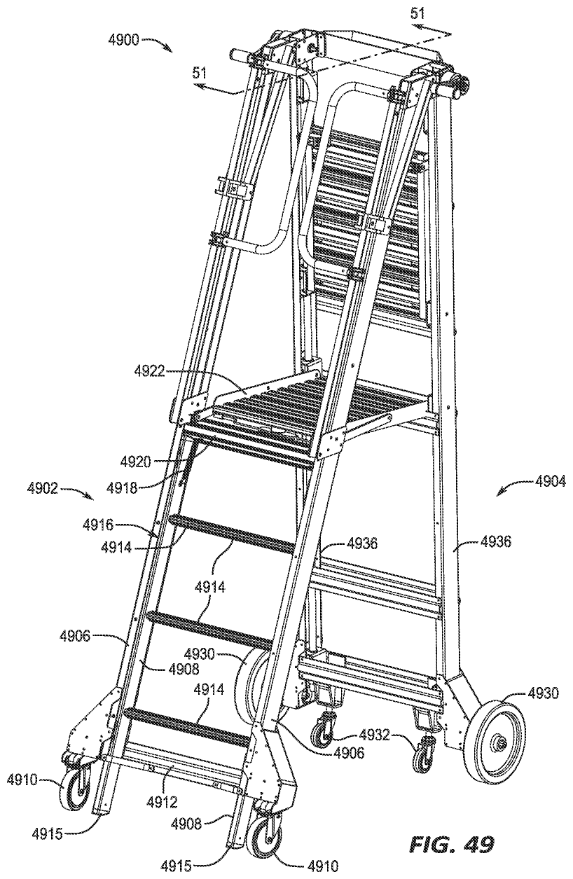

FIGS. 49-51C illustrate features of a wheeled platform system 4900 that may be implemented in connection with other embodiments disclosed herein. The system 4900 may include a first assembly 4902 and a second assembly 4904 that are movable, foldable, or collapsible relative to each other in a manner similar to assemblies 102 and 104 of system 100 or the related assemblies shown in system 3300. For example, the first and second assembly 4902, 4904 may be transitioned into a folded configuration (similar to FIGS. 2 and 4) and a standing configuration (shown in FIG. 49 and similar to FIGS. 1 and 3). The first assembly 4902 may include a pair of spaced apart outer rails 4906 and a pair of spaced apart inner rails 4908. The outer rails 4906 may be rotatably coupled to a pair of spaced apart rear rails 4936 of the second assembly 4904.

The outer rails 4906 may include a set of wheels 4910 (e.g., rotatable caster wheels) at their bottom ends. The outer rails 4906 may also be attached to each other by a support member or cross-bar 4912. The outer rails 4906 may lack any rungs between the cross-bar 4912 and the top rung 4920. Accordingly, the user may be obligated (or at least clearly intended and most directly facilitated) to step on the rungs 4914 of the inner rails 4908 in order to climb to the platform 4922 through the gates of the cage assembly on top of the system 4900.

The outer rails 4906 may each include an inward-facing three-sided channel (e.g., a C- or U-shaped channel) within which one or more (e.g., at least two) bearings or rail guides 4913 are positioned. The inner rails 4908 may be positioned within the bearings or rail guides 4913 to guide and facilitate sliding movement of the inner rails 4908 relative to the outer rails. For example, the rail guides 4913 may comprise a low-friction material (e.g., nylon) or a low-friction assembly (e.g., ball bearings contacting the rails 4908) to allow the inner rails 4908 to longitudinally and axially slide relative to the outer rails 4906. The rail guides 4913 may have a three-sided shape configuration to guide the position of the inner rails 4908 horizontally (e.g., to the left and right side of the system 4900) and longitudinally/axially along the outer rails 4906. In some embodiments, the rail guides 4913 may be mounted to the inner rails 4908 and may move with the inner rails 4908 instead of with the outer rails 4906.

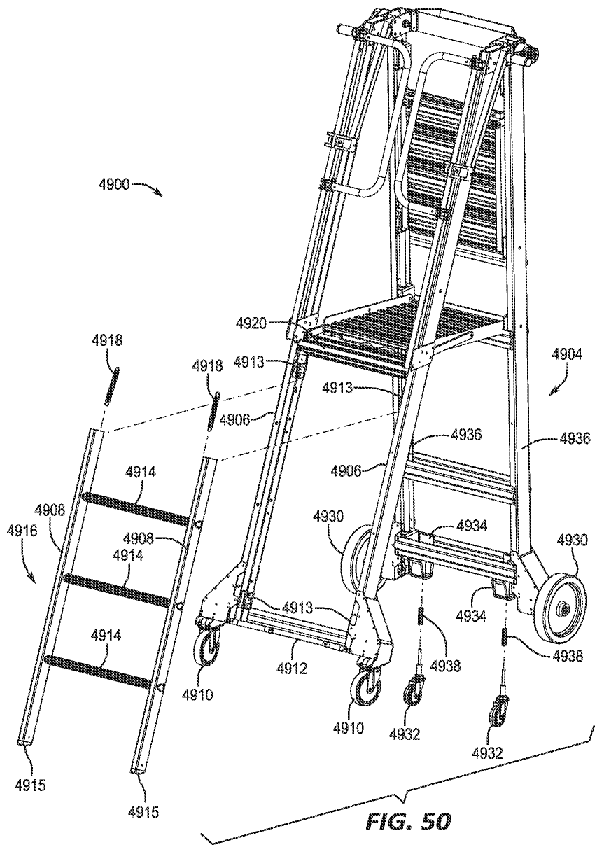

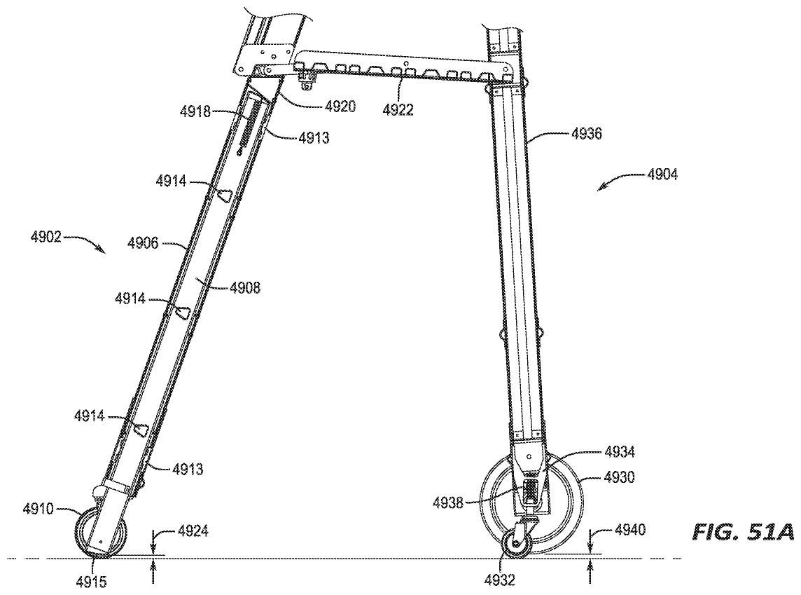

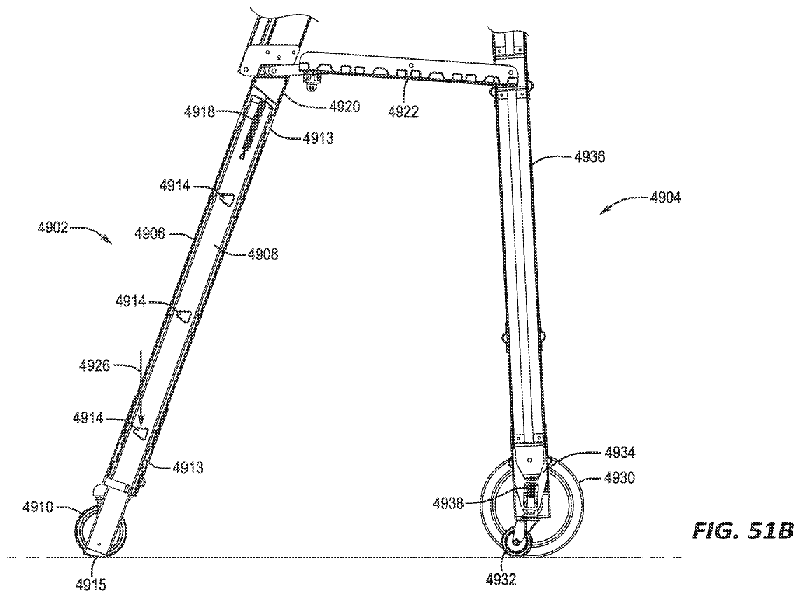

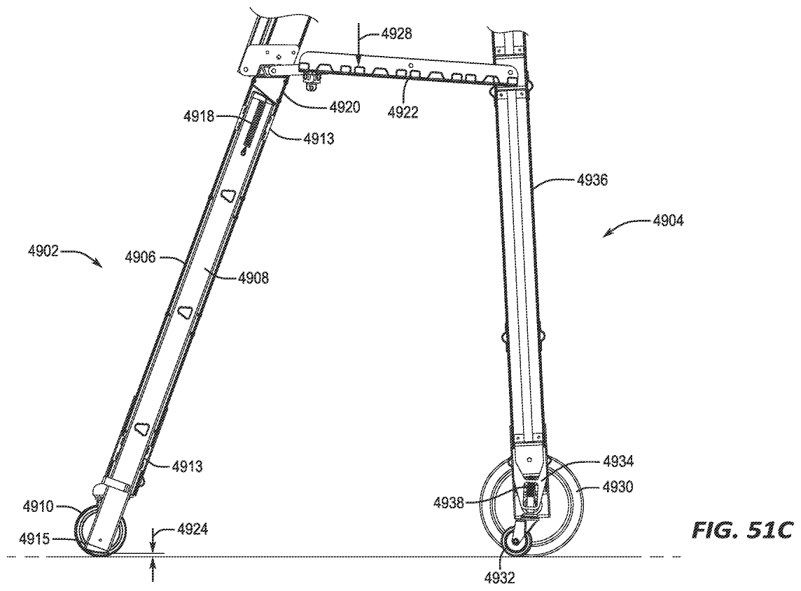

The inner rails 4908 may include a set of rungs 4914 which extend between the inner rails 4908 and which are parallel to each other. The rungs 4914 may be directly coupled to the inner rails 4908 and may not be coupled to the outer rails 4906, as shown in the partially exploded view of FIG. 50. The rungs 4914 may be usable as steps for supporting a user as he or she climbs onto the first assembly 4902. The inner rails 4908 may also include feet 4915 or other bottom components or bottom surfaces configured to abut a support surface underneath the system 4900 in certain configurations, as further explained in connection with FIGS. 51A-51C. The inner rails 4908 and rungs 4914 may collectively be referred to as a movable step assembly or a spring step assembly 4916.

The spring step assembly 4916 may be coupled and constrained to the rest of the system 4900 via at least one biasing member (e.g., springs 4918) in addition to the guides 4913. For example, springs 4918 may be directly coupled to brackets, fasteners, or other attachment features (e.g., welds or rivets) on surfaces of (e.g., the inner surfaces of) the inner rails 4908 and to surfaces of the outer rails 4906 or an outer rail rung 4920 or platform 4922. The outer rail rung 4920 and platform 4922 may be coupled to (or pivotally coupled to) the outer rails 4906 similar to the rung and platform of system 3300.

FIGS. 51A-51C show side section views of the system 4900 (as taken through central section lines 51-51 in FIG. 49) with upper ends of the springs 4918 attached to a downward-facing surface of the outer rail rung 4920. Thus, in the embodiment shown in system 4900, the springs 4918 are extension springs that bias the spring step assembly 4916 upward (i.e., toward the rung 4920 and platform 4922) relative to the outer rails 4906 and relative to a ground support surface under the system 4900. In some embodiments, the springs 4918 may be compression springs, leaf springs, or other biasing members that are configured to bias the spring step assembly 4916 upward in a similar manner, such as by being attached to the spring step assembly 4916 and a different part of the first assembly 4902 as compared to the embodiment shown in FIG. 49-51C. For example, compression springs may be attached to and extend between an outer surface of the inner rails 4908 and a guide 4913 and may be compressed when a user steps on a rung 4914.

In a first configuration, which may be referred to as a free movement configuration, wheel movement configuration, or caster movement configuration, the bottom end of the first assembly 4902 of the system 4900 may be supported only by the wheels 4910. The spring step assembly 4916 is biased upward and away from the ground support surface underneath the wheels 4910, as indicated by gap 4924 in FIG. 51A. The system 4900 may be in this configuration when a user is not applying a significant downward force (e.g., force 4926 in FIG. 51B) to any of the rungs 4914 of the spring step assembly 4916 (e.g., when the user is not standing on or otherwise supported by any of the rungs 4914). This first configuration may beneficially allow the user to reposition the system 4900 in any horizontal direction by pushing or pulling the system 4900 while standing on the ground surface near the system 4900 without braking or other significant resistance by the feet 4915 of the spring step assembly 4916. Thus, the user may need to apply a relatively low amount of force to reposition and roll the system 4900 on the wheels 4910.

In a second configuration, which may be referred to as a braking configuration or feet contact configuration, the bottom end of the first assembly 4902 of the system 4900 may be supported by the wheels 4910 and by the feet 4915 of the spring step assembly 4916. To reach the second configuration, the user may apply a downward force (e.g., force 4926) to the spring step assembly 4916, such as by stepping on one of the rungs 4914, thereby sliding the inner rails 4908 substantially downward and in a direction longitudinally parallel to/axially relative to the outer rails 4906 within the guides 4913, as shown in FIG. 51B. The spring step assembly 4916 may then come into contact with the ground surface (e.g., at feet 4915, as shown in FIG. 51B, wherein the gap 4924 is eliminated) and may support the weight of the user as he or she climbs onto the system 4900.

The feet 4915 may comprise a relatively high-friction material at their bottom surfaces, such as a rubber or other elastomeric material, to grip the ground surface and to resist rolling or sliding of the system 4900 on the ground surface. Similarly, the feet 4915 may be configured with spikes, tread features, or similar structures that, when engaging the ground surface, will limit horizontal movement of the system 4900 relative to the ground surface. In this second configuration, the system 4900 may have reduced horizontal movement and greater horizontal stability as the user steps onto the rungs 4914 and climbs up to the platform 4922. In some embodiments, this may be beneficial when the user first steps onto the lowermost rung 4914 with their first foot since the user's other foot is still planted on the ground surface, and the system 4900 may otherwise be more susceptible to wobbling or sliding as the user places their weight on the rungs 4914 and first attempts to climb.

As shown in FIG. 51C, once the user has ascended to the platform 4922 and no longer applies a downward force to the spring step assembly 4916, the user may apply a downward force 4928 (e.g., via their weight) to the platform 4922 or outer rail rung 4920. As a result, the biasing force applied by the springs 4918 may draw the spring step assembly 4916 upward and spaced away from the ground surface, re-introducing gap 4924, and the bottom end of the first assembly 4902 may be solely supported by the wheels 4910 again. This may be referred to as a third configuration, a platform-supporting configuration, or a driving user configuration. With the feet 4915 once again off the ground surface, the wheels 4910 can freely roll and rotate without the braking of the feet 4915. This may allow the user to maneuver, steer, and otherwise drive the system 4900 across the ground surface from the platform 4922 in the manner described in connection with user controls in various other embodiments disclosed herein. For example, the user may stand within a cage assembly and may rotate handles to independently drive wheels 4930 of the second assembly 4904.

The second assembly 4930 may include a pair of caster wheels 4932 (e.g., caster wheels) positioned between the drive wheels 4930. The pair of caster wheels 4932 may be mounted to at least one bracket 4934 (e.g., a pair of brackets) coupled with the pair of spaced apart rails 4936 of the second assembly 4904. Each bracket 4934 may include a substantially vertical opening aligned with a shaft extending from a caster wheel 4932. A spring 4938 or similar biasing member (shown in FIG. 50) may surround the shaft and may bias the caster wheel 4932 downward toward the ground surface. The shaft may be prevented from fully withdrawing from the bracket 4934 (e.g., when the wheel 4932 is lifted away from the ground) by a pin, fastener, or other mechanical interference.

The rear caster wheels 4932 may be biased toward a first configuration shown in FIG. 51A, which may be referred to as a free movement configuration or caster-only support configuration. The springs 4938 may apply a sufficient force to support the weight of the bottom end of the second assembly 4904 of the platform 4900 and to suspend the drive wheels 4930 above the ground surface, thereby forming a gap 4940 between the bottom of the drive wheel 4930 and the ground surface. Accordingly, the user may push or pull the system 4900 in any horizontal direction by moving only the caster wheels 4932 and wheels 4910. In this configuration, the user is also not applying any significant downward-oriented force to the system at the first assembly 4902, outer rail rung 4920, or platform 4922 (e.g., a downward force sufficient to overcome the biasing force of the springs 4938).

Once the user applies a downward force to the spring step assembly (e.g., 4926), the biasing force of the springs 4938 may be overcome, thereby driving the caster wheels 4932 upward toward the brackets 4934 and driving the drive wheels 4930 downward into contact with the ground surface, as shown in FIG. 51B. This may be referred to as a second configuration of the rear caster wheels 4932, a climbing configuration or caster-and-drive-wheel support configuration for the second assembly 4904. In this state, the platform 4900 is more stabilized against lateral movement (e.g., horizontally to the left and right of the user) as the user climbs the spring step assembly 4916 because the drive wheels 4930, which do not rotate about a vertical axis, are in contact with the ground surface. Thus, the drive wheels 4930, in combination with the feet 4915, may stabilize horizontal movement of the platform 4900 while the user climbs. Additionally, mechanical braking of the drive wheels 4930 (e.g., braking similar to the worm gear configuration shown in connection with gears 3770 and 3772, brake 600, or associated with user controls of FIGS. 10-32C) may limit horizontal movement at the bottom of the second assembly 4904 in a front-to-back direction by limiting axial rotation of the drive wheels 4930 about their axles.

Once the user reaches the top rung 4920 and platform 4922, as shown in FIG. 51C, the spring step assembly 4916 may move to its third configuration (described above), and the rear caster wheels 4932 and drive wheels 4930 may remain in contact with the ground surface. Thus, the user can drive the platform system 4900 from the platform 4922 via the drive wheels 4930 (because the wheels 4930 contact the ground) without dragging or bring braked by the feet 4915 of the spring step assembly 4916. Once the user no longer applies a downward force to the system 4900, the rear caster wheels 4932 may return to their first configuration (FIG. 51A), re-introducing gap 4940.

The configurations of the wheels 4910, 4930, 4932 and spring step assembly 4916 shown in FIGS. 51A-51C can each be referred to as a configuration of the system 4900. For example, FIG. 51A may be referred to as showing first configuration (e.g., a laterally free-moving configuration), FIG. 51B may be referred to as showing a second configuration (e.g., a movement-restricted configuration), and FIG. 51C may be referred to as showing a third configuration (e.g., a user-driving or piloted configuration).

In some embodiments, the storage position support wheels 3317 may operate in the manner described in connection with rear caster wheels 4932. The support wheels 3317 may be biased downward and capable of suspending the drive wheels 3314 away from the ground surface when the platform system 3300 is unloaded and not supporting a user. Additionally, in some embodiments, the system 3300 may be implemented with a spring step assembly 4916 and wheels 4910 positioned in or attached to the front rails.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.” As used in the specification, “and” and “or” shall have the same meaning as “and/or,” wherein, unless context mandates otherwise, these conjunctions can be read inclusively or exclusively.

What is claimed is:

1. A drivable platform, comprising:
a first rail having a bottom end;
a first wheel positioned at the bottom end of the first rail, the first wheel being coupled with a first driver;
a second rail having a bottom end;
a second wheel positioned at the bottom end of the second rail, the second wheel being coupled with a second driver;
a first control assembly coupled with the first rail above the bottom end and including a first handle and a third driver;
a second control assembly coupled with the second rail above the bottom end and including a second handle and a fourth driver;
a first transmission member configured to couple rotation of the first driver and the third driver;
a second transmission member configured to couple rotation of the second driver and the fourth driver; and
a platform coupled to the first rail and the second rail;
wherein the first handle is rotatable to drive rotation of the first wheel and the second handle is rotatable to drive rotation of the second wheel; and
wherein the first wheel is rotatable independent of the second wheel.

2. The drivable platform of claim 1, wherein the first control assembly includes a crank coupled with the third driver and with the first handle.

3. The drivable platform of claim 1, wherein the first wheel is rotatable in an opposite direction from the second wheel by operation of the first and second control assemblies.

4. The drivable platform of claim 1, wherein at least the first transmission member comprises a chain engaging with a set of teeth on the first driver and with a set of teeth on the third driver.

5. The drivable platform of claim 1, wherein at least the first transmission member comprises an upper transmission member coupled with the first driver and a lower transmission member coupled with the third driver.

6. The drivable platform of claim 1, further comprising a brake coupled with at least one of the first and second rails, the brake being rotatable to a position braking movement of at least one of the first and second transmission members.

7. The drivable platform of claim 1, wherein at least one of the first and second handles automatically brakes rotation of at least one of the third and fourth drivers.

8. A driving apparatus for a mobile platform, comprising:
a rail;
a drive system extending from a bottom end of the rail to a position above the bottom end of the rail;
a wheel connected to the drive system at the bottom end of the rail;
a crank arm rotatably coupled to a portion of the drive system at the position above the bottom end of the rail; and
a handle coupled to the crank arm and movable between a first position and a second position relative to the drive system;
wherein with the handle in the first position, a brake limits rotation of the crank arm; and
wherein with the handle in the second position, the brake is released, and the crank arm is rotatable to drive the drive system.

9. The driving apparatus of claim 8, wherein the handle is biased to the first position.

10. The driving apparatus of claim 8, wherein the handle is rotatable between the first position and the second position within a plane intersecting an elongated dimension of the crank arm, the first position being angularly offset from the second position.

11. The driving apparatus of claim 8, wherein the handle is translatable perpendicular to an elongated dimension of the crank arm to move between the first position and the second position.

12. The driving apparatus of claim 8, wherein the handle is translatable parallel to an elongated dimension of the crank arm to move between the first position and the second position.

13. The driving apparatus of claim 8, wherein the brake comprises a pin movable between a braking position engaging a plate of the drive system while the handle is in the first position and a released position spaced away from the plate while the handle is in the second position.

14. The driving apparatus of claim 13, wherein the plate radially extends relative to an axis of rotation of the crank arm.

15. The driving apparatus of claim 8, wherein the brake is released by rotating the handle from the first position to the second position.

16. A wheeled platform, comprising:
a first assembly including:
a first pair of spaced apart rails;
at least one rung extending between and coupled to the first pair of spaced apart rails;
a first pair of wheels coupled to respective bottom ends of the first pair of spaced apart rails; and
a first pair of hinge portions coupled to the first pair of spaced apart rails;
a second assembly including:
a second pair of spaced apart rails;
a second pair of wheels coupled to respective bottom ends of the second pair of spaced apart rails; and
a second pair of hinge portions coupled to the second pair of spaced apart rails, wherein the first pair of hinge portions and the second pair of hinge portions are coupled to each other to form a pair of pivotable hinges movable between a first position in which the first pair of rails extends at a non-parallel angle relative to the second pair of rails and a second position in which the first pair of rails extends parallel to the second pair of rails; and
at least one platform coupled with and extending between the first assembly and the second assembly below the pair of pivotable hinges.

17. The wheeled platform of claim 16, further comprising a drive system including:
a rotatable handle at an upper end of at least one of the first and second assemblies; and
a drive link configured for transferring a torque applied to the rotatable handle to at least one wheel of the first pair of wheels or at least one wheel of the second pair of wheels.

18. The wheeled platform of claim 16, wherein the at least one platform is pivotable relative to the first and second assemblies.

19. The wheeled platform of claim 16, wherein at least the first pair of spaced apart rails is adjustable between a first length configuration and a second length configuration, the first length configuration being shorter than the second length configuration.

20. The wheeled platform of claim 16, further comprising a spacer bar system extending between a bottom end of a rail of the first pair of spaced apart rails and a bottom end of a rail of the second pair of spaced apart rails, the spacer bar system having an adjustable length.
